(19) United States
(12) Patent Application Publication
(10) Pub. No.: US 2025/0017715 A1
(43) Pub. Date: Jan. 16, 2025

(54) SYSTEM FOR TRACKING, COORDINATION, AND CONTROL OF LIVESTOCK BIRTHING OPERATIONS

(71) Applicant: SwineTech, Inc., Solon, IA (US)

(72) Inventors: MATTHEW ROODA, North Liberty, IA (US); Adam Magstadt, Marion, IA (US); Jesse Bries, Newhall, IA (US); Ben White, Cedar Rapids, IA (US); Joseph Palermo, Cedar Rapids, IA (US)

(21) Appl. No.: 18/734,067

(22) Filed: Jun. 5, 2024

Related U.S. Application Data
(60) Provisional application No. 63/506,487, filed on Jun. 6, 2023.

(51) Int. Cl. A61D 17/00; A01K 1/02; A01K 5/02; A01K 29/00

(52) U.S. Cl. CPC A61D 17/008; A01K 1/0218; A01K 5/0291; A01K 29/005

(57) ABSTRACT

In one or more arrangements, a system for tracking, coordination, and/or control of livestock birthing operations is presented. In one or more arrangements the system includes a backend system and one or more personal electronic devices communicatively connected to the backend system. The personal electronic devices are configured to provide a user interface for workers to monitor and update information for a set of farrowing livestock animals in the backend system. In one or more arrangements, the system provides a platform implemented by operations coordination software on the backend system and the user interface on the personal electronic devices. The platform is designed to serve as the epicenter of day-to-day operations in livestock operations, tracking and providing critical information about employee performance, animal health, animal production, and link with and/or control performance of automated agricultural equipment and/or third-party technologies.

### REFERENCE TO RELATED PATENT APPLICATIONS

This patent application claims priority to U.S. Provisional Patent Application 63/506,487 filed on Jun. 6, 2023, which is hereby fully incorporated by reference herein in its entirety.

### FIELD OF THE DISCLOSURE

This disclosure relates generally to tracking systems. More specifically, and without limitation, this disclosure relates generally to systems for tracking, coordination, and/or control of livestock operations.

### OVERVIEW

There are many challenges in maintaining healthy animals in livestock production. A variety of health conditions may arise in an animal population such as dehydration, illness, heat stroke, freezing, which can lead to mortality or poor growth rate.

Birthing in livestock operations can be particularly challenging. For example, in farrowing of swine, various complications may occur during and after birth due to sow health and age, disease, environmental conditions, among other factors. For instance, some complication that may occur in the birthing process include but are not limited to prolonged labor, excessive straining, stuck piglets in the birth canal, or stillborn piglets not breathing. A sow must be regularly checked during the birthing process of a litter to address and mitigate complications as they occur.

Care must also be taken after birth to ensure a mothering sow receives proper nutrition and water to support lactation and ensure the sow has a sufficient number of functional tits to support the litter size. It is also important to monitor and control environmental conditions after birth. For example, failure to provide piglets with sufficient external heat may lead to the death of some piglets from chilling, starvation, and disease. While piglets may lie against the sow for warmth, this increases the chances of the sow rolling over and suffocating or crushing the piglets. If risk of suffocating or crushing the piglets is observed, it may be desirable to separate sow and piglet in separate areas (e.g., by a fence) in the farrowing crate after birthing.

These challenges of farrowing are further complicated by the large number of sows that may be farrowing at the same time. Current methods to monitor livestock such as manually walking barns for visual inspection and/or video surveillance can be time-consuming and/or ineffective method for monitoring sows and piglets to ensure that farrowing complications, environmental hazards, health issues, equipment failures, and/or other issues are quickly addressed.

Therefore, for all the reasons stated above, and the reasons stated below, there is a need in the art for a livestock monitoring system that improves upon the state of the art. Thus, it is a primary object of the disclosure to provide a livestock monitoring system that improves upon the state of the art.

Another object of the disclosure is to provide a system for tracking, coordination, and/or control of livestock operations.

Yet another object of the disclosure is to provide a system configured to facilitate tracking, coordination, and/or control of farrowing operations for livestock.

Another object of the disclosure is to provide a system that automatically identifies livestock at high risk of complications during farrowing.

Yet another object of the disclosure is to provide a system configured to schedule and track check ins on farrowing livestock.

Another object of the disclosure is to provide a system configured to dynamically schedule and track check ins on farrowing livestock based on determined risk.

Yet another object of the disclosure is to provide a system for tracking, coordination, and/or control of livestock operations in farrowing that reduces risk and increases birthing rates.

Another object of the disclosure is to provide a system for tracking, coordination, and/or control of livestock operations through the entire lifecycle of the livestock.

Yet another object of the disclosure is to provide a system for tracking, coordination, and/or control of livestock operations that facilitates creation and tracking of tasks.

Another object of the disclosure is to provide a system for tracking, coordination, and/or control of livestock operations that is high quality.

Yet another object of the disclosure is to provide a system for tracking, coordination, and/or control of livestock operations that is easy to use.

Another object of the disclosure is to provide a system for tracking, coordination, and/or control of livestock operations that is reliable.

These and other objects, features, or advantages of the disclosure will become apparent from the specification, figures, and claims.

### SUMMARY

In one or more arrangements, a system for tracking, coordination, and/or control of livestock birthing operations is presented. In one or more arrangements the system includes a backend system and one or more personal electronic devices communicatively connected to the backend system. The personal electronic devices are configured to provide a user interface for workers to monitor and update information for a set of farrowing livestock animals in the backend system.

In one or more arrangements, the system provides an innovative and versatile platform implemented by operations coordination software on the backend system and the user interface on the personal electronic devices. The platform is designed to serve as the epicenter of day-to-day operations in livestock operations, tracking and providing critical information about employee performance, animal health, animal production, and link with and/or control performance of automated agricultural equipment and/or third-party technologies.

In one or more arrangements, the system is configured to perform data analytics using artificial intelligence to identify various areas of opportunity, prioritize tasks, optimize connected technologies, genetically select breeding stock, identify high risk animals, and/or identify complications, among other actions. In one or more arrangements, the system is configured to provide recommendations on workflows, ideal personnel for a task, and/or guidance on performing tasks for optimal care and financial outcomes.

In one or more arrangements, the system is configured to measure compliance with compliance polices to ensure proper care of livestock. In one or more arrangements compliance polices may tank into account multiple variables such as the age of the piglets, parity of the sow, and/or time of day when determining compliance. Additionally or alternatively, compliance polices may factor in the frequency of check ins, the number of newborns per check in, and/or the number of sows farrowing per active caregiver to calculate compliance.

In one or more arrangements, the system is configured to facilitate creation, scheduling, assigning and/or management of tasks and in some arrangements may dynamically create and/or adjust tasks as needed based on, for example, tracked actions of workers and/or statuses of livestock. For instance, in some arrangements, the system may even drive medication treatments in a multifactorial way, allowing for adjustments to the treatment regimen if needed.

As applicable to the specific application of farrowing, in one or more arrangements, the backend system is configured to maintain respective timers indicating when the workers are scheduled to check in on the set of farrowing livestock animals. In one or more arrangements, the user interface is configured to display a listing of the set of farrowing livestock animals along with respective timers. In one or more arrangements, the listing of the set of farrowing livestock animals is sorted according to the times remaining on the respective timers for the set of farrowing livestock animals, thereby permitting workers to easily assess and prioritize check ins. In one or more arrangements, the backend system is configured to determine birthing risk for the set of farrowing livestock animals (e.g., based on data from previous farrowing cycles, medical history, and/or data from the current farrowing cycle) and set the timers based on the determined risk.

### BRIEF DESCRIPTION OF THE DRAWINGS

FIG. 1 shows a system for tracking, coordination, and/or control of livestock birthing operations, in accordance with one or more arrangements.

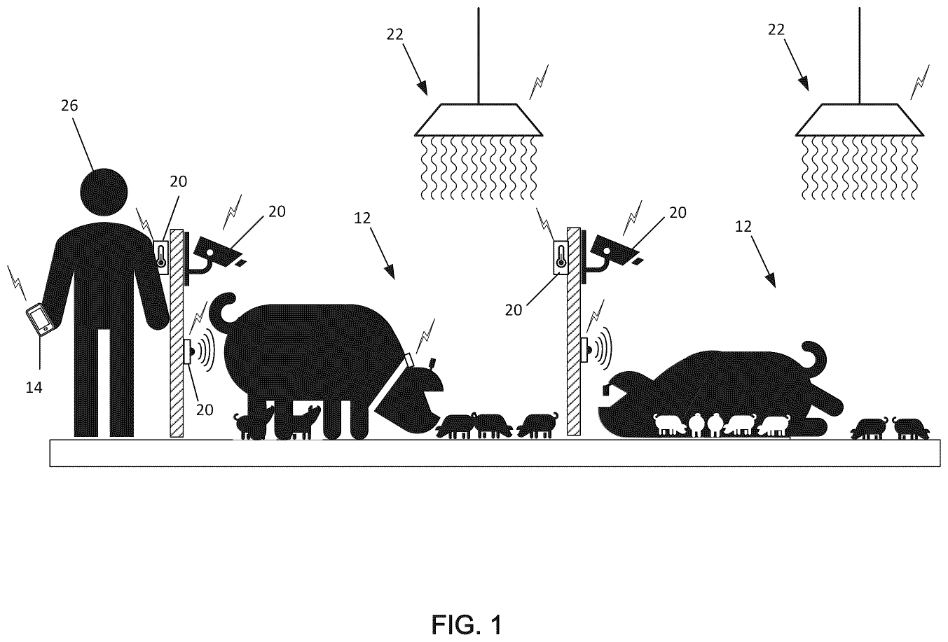

FIG. 2 shows a system for tracking, coordination, and/or control of livestock birthing operations, in accordance with one or more arrangements.

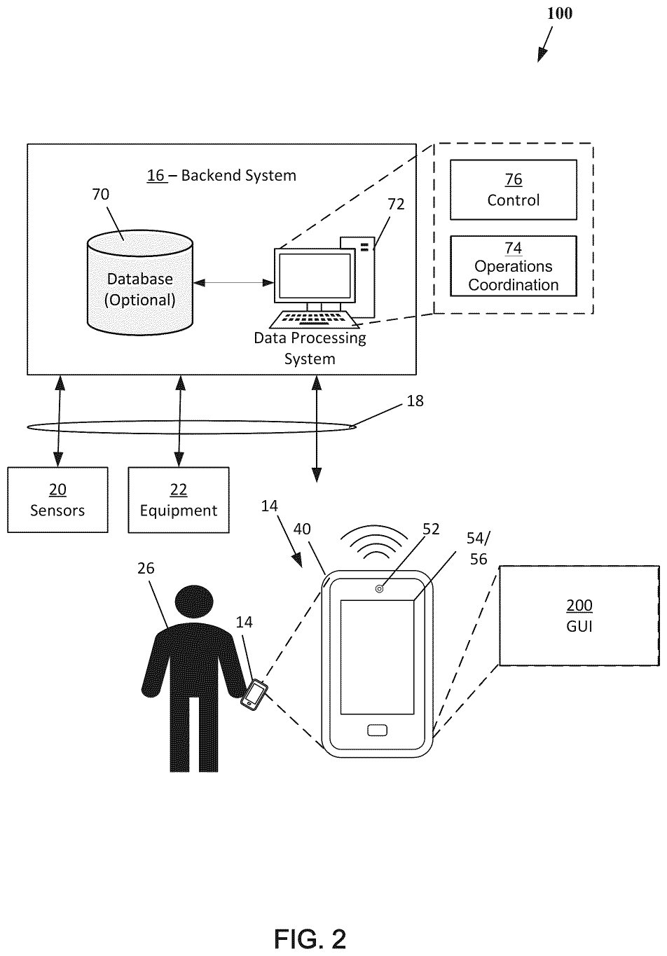

FIG. 3 show a diagram of an example personal electronic device that may be used to provide a user interface to facilitate tracking, coordination, and/or control of livestock operations, in accordance with one or more arrangements.

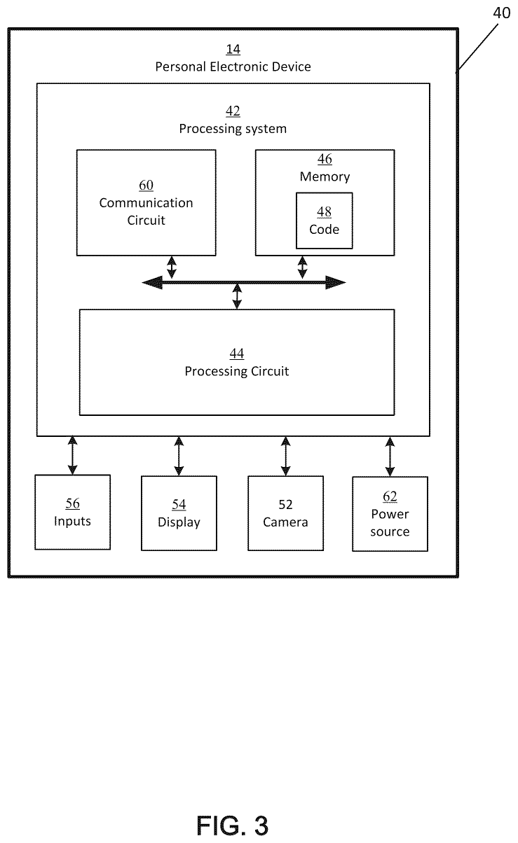

FIG. 4 shows an example process for determining risk for farrowing livestock animals and scheduling check in times as a function of risk, in accordance with one or more arrangements.

FIG. 5 shows a screenshot of an example user interface for a system for tracking, coordination, and/or control of livestock birthing operations; in accordance with one or more arrangements; the user interface showing a Farrowing Dashboard displayed.

FIG. 6 shows a screenshot of the example user interface shown in FIG. 5, in accordance with one or more arrangements; the screenshot showing a pop up window with additional information that is displayed in response to a user clicking on a farrowing goal.

FIG. 7 shows a screenshot of a Walk Farrowing tool accessible from the Farrowing Dashboard shown in FIG. 5, in accordance with one or more arrangements; the Walk Farrowing tool showing information for a list of rooms.

FIG. 8 shows a screenshot of an example interface of the Walk Farrowing tool shown in FIG. 7, in accordance with one or more arrangements; the interface displaying information for a number of crates with sows ready for farrowing for a selected room.

FIG. 9 shows a screenshot of an example interface of the Walk Farrowing tool shown in FIG. 7, in accordance with one or more arrangements; the interface displaying information for a number of crates that have piglets.

FIG. 10 shows a screenshot of an example user interface of the Walk Farrowing tool shown in FIG. 7, in accordance with one or more arrangements; the screenshot showing an example interface editing information for a selected crate.

FIG. 11 shows a screenshot of an example user interface of the Walk Farrowing tool shown in FIG. 7, in accordance with one or more arrangements; the screenshot showing an example interface presenting a number of flags that may be selected by a worker with flags selected for being off feed and lameness.

FIG. 12 shows a screenshot of an example Farrow Tracker tool accessible from the Farrowing Dashboard shown in FIG. 5, in accordance with one or more arrangements.

FIG. 13 shows a screenshot of the Farrow Tracker tool shown in FIG. 12, in accordance with one or more arrangements; the screenshot showing a pop up interface for filtering results.

FIG. 14 shows a screenshot of the Farrow Tracker tool shown in FIG. 12; in accordance with one or more arrangements; the screenshot showing an example check in interface.

FIG. 15 shows a screenshot of an example Liters to Foster tool accessible from the Farrowing Dashboard shown in FIG. 5, in accordance with one or more arrangements.

FIG. 16 shows a screenshot of an example an example litter balance interface of the Liters to Foster tool shown in FIG. 15, in accordance with one or more arrangements.

FIG. 17 shows a screenshot of example Litters to Process tool accessible from the Farrowing Dashboard shown in FIG. 5, in accordance with one or more arrangements.

FIG. 18 shows a screenshot of an example user interface shown in FIG. 17, in accordance with one or more arrangements; the screenshot showing drop down list for a selected room with a listing of crates therein.

FIG. 19 shows a screenshot of an example Litters to Wean tool accessible from the Farrowing Dashboard shown in FIG. 5, in accordance with one or more arrangements.

FIG. 20 shows a screenshot of an example Unstaged Litters interface of the example Litters to Wean tool shown in FIG. 18, in accordance with one or more arrangements.

FIG. 21 shows a screenshot of the Unstaged Litters interface shown in FIG. 19 with a dropdown list of crates shown for a selected room, in accordance with one or more arrangements.

FIG. 22 shows a screenshot of a Farrowing Issues tool accessible from the Farrowing Dashboard shown in FIG. 5, in accordance with one or more arrangements; the screenshot showing the Farrowing Issues tool providing a scrollable list of all sows and/or litters that are flagged.

FIG. 23 shows a screenshot of the Farrowing Issues tool shown in FIG. 22, in accordance with one or more arrangements; the screenshot showing a pop up interface for filtering results.

FIG. 24 shows a screenshot of an example user interface for a system for tracking, coordination, and/or control of livestock birthing operations; in accordance with one or more arrangements; the screenshot showing a Gestation Dashboard displayed.

FIG. 25 shows a screenshot a Create Pig tool accessible from the Gestation Dashboard shown in FIG. 24, in accordance with one or more arrangements.

FIG. 26 shows a screenshot of a Walk Gestation tool accessible from the Gestation Dashboard shown in FIG. 24, in accordance with one or more arrangements.

FIG. 27 shows a screenshot of an Active Services tool accessible from the Gestation Dashboard shown in FIG. 24, in accordance with one or more arrangements.

FIG. 28 shows a screenshot of the Active Services tool shown in FIG. 27, in accordance with one or more arrangements; the screenshot showing a drop down menu expanded to show sows that have mated twice.

FIG. 29 shows a screenshot of a Bulk Breed tool accessible from the Gestation Dashboard shown in FIG. 24, in accordance with one or more arrangements.

FIG. 30 shows a screenshot of an edit menu of the Bulk Breed tool shown in FIG. 29, in accordance with one or more arrangements.

FIG. 31 shows a screenshot of the Bulk Breed tool shown in FIG. 29, in accordance with one or more arrangements; the screenshot showing the Bulk Breed tool displaying information for a specified sow.

FIG. 32 shows a screenshot of a Pregnancy Check List tool accessible from the Gestation Dashboard shown in FIG. 24, in accordance with one or more arrangements.

FIG. 33 shows a screenshot of a Move In List tool accessible from the Gestation Dashboard shown in FIG. 24, in accordance with one or more arrangements.

FIG. 34 shows a screenshot of the Move In List tool shown in FIG. 33, in accordance with one or more arrangements; the screenshot showing a drop down list expanded showing sows in a selected breed group.

FIG. 35 shows a screenshot of a Cull Sows tool accessible from the Gestation Dashboard shown in FIG. 24, in accordance with one or more arrangements.

FIG. 36 shows a screenshot of the Cull Sows tool shown in FIG. 35, in accordance with one or more arrangements; the screenshot showing a drop down list expanded showing sows that are ready to sell.

FIG. 37 shows a screenshot of a Gestation Issues tool accessible from the Gestation Dashboard shown in FIG. 24, in accordance with one or more arrangements.

FIG. 38 shows a screenshot of a Gestation Issues tool shown in FIG. 37, in accordance with one or more arrangements; the screenshot showing a pop up interface for filtering results.

FIG. 39 shows a screenshot of an example user interface for a system for tracking, coordination, and/or control of livestock birthing operations; in accordance with one or more arrangements; the screenshot showing a Tasks Dashboard displayed; the Task Dashboard organizing tasks into open tasks, tasks in progress, and closed tasks; the screenshot showing an expanded list of the closed tasks.

FIG. 40 shows a screenshot of the Tasks Dashboard shown in FIG. 39, in accordance with one or more arrangements; the screenshot showing an expanded list of the tasks in progress.

FIG. 41 shows a screenshot of the Tasks Dashboard shown in FIG. 39, in accordance with one or more arrangements; the screenshot showing a pop up interface displaying additional information for a selected task and an option for the user to start the selected task.

FIG. 42 shows a screenshot of the Tasks Dashboard shown in FIG. 39, in accordance with one or more arrangements; the screenshot showing a pop up interface for filtering the lists of tasks.

FIG. 43 shows a screenshot of the Tasks Dashboard shown in FIG. 39, in accordance with one or more arrangements; the screenshot showing an interface for adding a new task.

FIG. 44 of an example user interface for a system for tracking, coordination, and/or control of livestock birthing operations; in accordance with one or more arrangements; the screenshot showing an example chat interface.

FIG. 45 shows a screenshot of an alternate arrangement of the Farrowing Dashboard shown in FIG. 5, in accordance with one or more arrangements; the screenshot showing the Farrow Tracker tool replaced with an Early Pig Care tool.

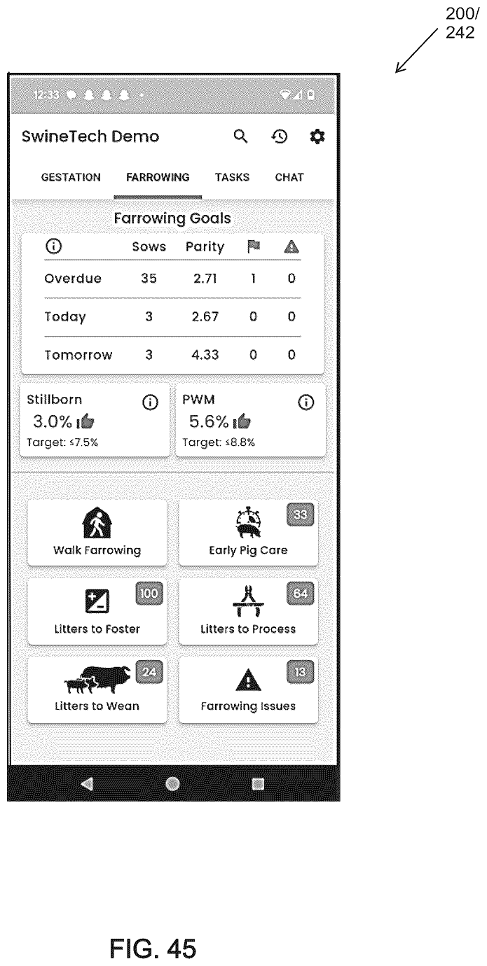

FIG. 46 shows a screenshot of an example Early Pig Care tool accessible from the Farrowing Dashboard, in accordance with one or more arrangements; the screenshot showing entries filtered to display all sows and all split sickling piglets.

FIG. 47 shows a screenshot of an example Early Pig Care tool accessible from the Farrowing Dashboard, in accordance with one or more arrangements; the screenshot showing entries filtered to display split sickling piglets.

FIG. 48 shows a screenshot of an example Early Pig Care tool accessible from the Farrowing Dashboard, in accordance with one or more arrangements, in accordance with one or more arrangements; the screenshot showing entries filtered to display split sickling piglets and at risk sows; the screenshot showing a warning displayed to indicate that a proposition 12 exception has expired for 1 sow.

FIG. 49 shows a screenshot of an example Early Pig Care tool accessible from the Farrowing Dashboard, in accordance with one or more arrangements; the screenshot showing a pop up interface for filtering entries to be displayed.

FIG. 50 shows a screenshot of an example Walk Gestation tool accessible from the Gestation Dashboard, in accordance with one or more arrangements; the screenshot showing a warning displayed to indicate that a proposition 12 exception has expired for 1 sow.

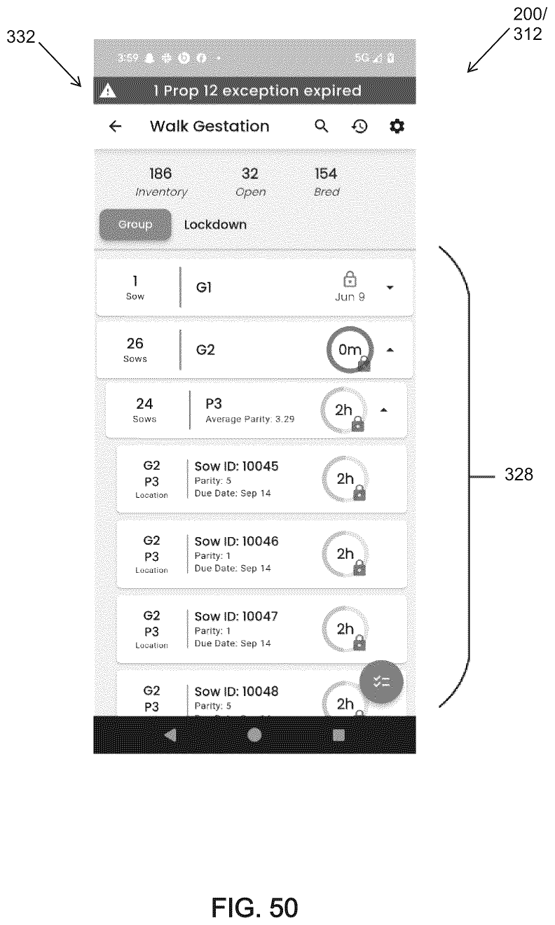

FIG. 51 shows a screenshot of an example Walk Gestation tool accessible from the Gestation Dashboard, in accordance with one or more arrangements; the screenshot showing a warning displayed to indicate that a proposition 12 exception has expired for 1 sow; the screenshot showing status warning for two groups of sows that have litters that are over capacity.

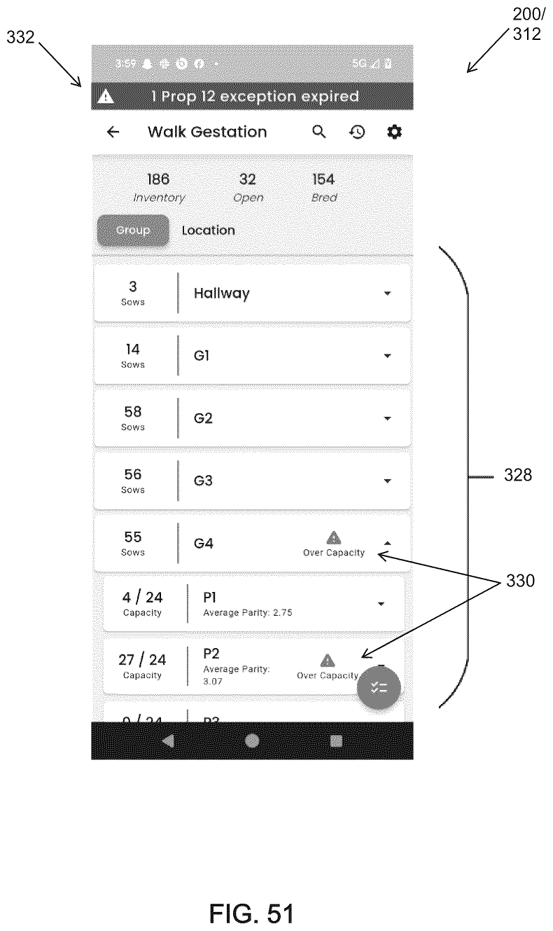

FIG. 52 shows a screenshot of an example interface screens to facilitate setup and configuration of some example settings for operations coordination software, in accordance with one or more arrangements.

FIG. 53 shows a screenshot of an example interface screens to facilitate setup and configuration of some example settings for operations coordination software, in accordance with one or more arrangements.

FIG. 54 shows a screenshot of an example interface screens to facilitate setup and configuration of some example settings for operations coordination software, in accordance with one or more arrangements.

FIG. 55 shows a screenshot of an example report that may be provided by an example interface of operations coordination software, in accordance with one or more arrangements; the report showing a graphical overview of compliance and some data metrics.

FIG. 56 shows a screenshot of an example report that may be provided by an example interface of operations coordination software, in accordance with one or more arrangements; the report showing a graphical overview of some various data metrics on mating, farrowing, sleeving rates, and risk associated with checkup times.

FIG. 57 shows a screenshot of an example report that may be provided by an example interface of operations coordination software, in accordance with one or more arrangements; the report showing a graphical overview of some various data metrics on hourly checkup compliance, litter balance and target litter size, and processing age.

FIG. 58 shows a screenshot of an example report that may be provided by an example interface of operations coordination software, in accordance with one or more arrangements; the report showing a graphical overview of some various data metrics on weening and policy compliance in provision of services and checkups.

FIG. 59 shows a screenshot of an example report that may be provided by an example interface of operations coordination software, in accordance with one or more arrangements; the report showing a graphical overview of some various data metrics on litter balance and policy compliance for processed litters and weened litters.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the disclosure. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the disclosure that may be described herein. The contemplated embodiments are not so limited and should not be interpreted as being restricted to embodiments which address such objects of the disclosure. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present disclosure to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously introduced and not, while definite articles like “the” refer to a same previously introduced term; as such, it is understood that “a” or “an” modify items that are permitted to be previously introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of animal husbandry of sows. However, the embodiments are not so limited. It is appreciated that the embodiments may be adapted for use in other applications and/or systems, which may be improved by the disclosed structures, arrangements and/or methods. The system is merely shown and described in the context of animal husbandry of sows for ease of description and as one of countless examples.

### System 10:

In various embodiments, a system for management and control of livestock birthing operations 10 (or simply system 10) is presented. System 10 may be formed of any suitable size, shape, and design and is configured to facilitate monitoring, management, and/or control of livestock animals 12, tasks, or operation of automated equipment, for example, to assist in the care of livestock animals 12.

In one or more arrangements, the system 10 includes one or more personal electronic devices 14 and a backend system 16 communicatively connected to the personal electronic devices 14, among other components. Personal electronic device(s) 14 and backend system 16 are communicatively connected over one or more data networks 18. In one or more arrangements, the system 10 also includes one or more sensors 20 communicatively connected to backend system 16 and configured to record data related to the care of livestock animals 12. In one or more arrangements, the system 10 also includes agricultural equipment 22 configured to perform various actions responsive to backend system 16 to facilitate in the care of livestock animals 12.

### Personal Electronic Device 14:

In one or more arrangements, system 10 includes a personal electronic device 14. Personal electronic device 14 is formed of any suitable size, shape, design, and/or technology and is configured to provide a user interface to facilitate tracking, coordination, and/or control of livestock operations by workers 26 (or users 26).

In the arrangement shown, as one example, personal electronic device 14 includes a housing 40, a processing system 42, a display 54, inputs 56, a camera 52, and a power source 62, among other components. In the arrangement shown, as one example, personal electronic device 14 is a conventional cell phone, smart phone, tablet, laptop, desktop computer, or the like, however any other form of a device having a display 54 is hereby contemplated for use.

### Housing 40:

In the arrangement shown, as one example, personal electronic device 14 includes a housing 40. Housing 40 is formed of any suitable size, shape, and design and is configured provide the exterior shell of personal electronic device 14. In one arrangement shown, as one example, housing 40 is a generally elongated member that is longer than it is wide, and it is wider than it is deep and in this way housing 40 fits well within the hand of a user 26. Housing 40 houses and holds and protects the other components of personal electronic device 14.

### Processing System 42:

In the arrangement shown, as one example, personal electronic device 14 includes a processing system 42. Processing system 42 is formed of any suitable size, shape, design, and/or technology and is configured to control operation of other components of personal electronic device 14 to facilitate computational operation of personal electronic device 14. In the arrangement shown, as one example, processing system 42 includes a processing circuit 44 and memory 46 having software code 48 or instructions that facilitates the display and adjustment of images on display 54, and a communication circuit 60, among other components.

Processing circuit 44 may be any computing device that receives and processes information and outputs commands according to software code 48 or instructions stored in memory 46. Memory 46 may be any form of information storage such as flash memory, ram memory, dram memory, a hard drive, or any other form of memory. Processing circuit 44 and memory 46 may be formed of a single combined unit. Alternatively, processing circuit 44 and memory 46 may be formed of separate but electrically connected components. Alternatively, processing circuit 44 and memory 46 may each be formed of multiple separate but electrically connected components.

Software code 48 or instructions is any form of information or rules that direct processing circuit 44 how to receive, interpret and respond to information to operate as described herein. Software code 48 or instructions is stored in memory 46 and accessible to processing circuit 44. As an illustrative example, in one or more arrangements, software code or instructions may configure processing circuit 44 to control camera 52, display 54, and inputs 56 to provide a graphical user interface for user 26 to interact with system 10 to review and/or update statuses of livestock animals 12 and/or tasks related to the care of the livestock animals 12.

### Communication Circuit 60:

In the arrangement shown, as one example, personal electronic device 14 includes a communication circuit 60. Communication circuit 60 is formed of any suitable size, shape, design, and/or technology and is configured to facilitate communication with backend system 16. In one or more arrangements, as one example, communication circuit 60 includes a transceiver circuit and an antenna. A transceiver is any electronic device that facilitates two-way communication, that is, the delivery of information from personal electronic device 14 to other components of the system 10 as well as the reception of information from other components of the system 10 to personal electronic device 14. An antenna is any device that is configured to receive wireless signals from over-the-air communication and/or transmit wireless signals in over-the-air communication. In an example arrangement, a transceiver of communication circuit 60 is connected with a respective antenna, which may be a monopole antenna, dipole antenna, a loop antenna, a fractal antenna, or any other form of an antenna, to facilitate transmission and/or reception of signals in the form of electromagnetic radio frequencies. Additionally or alternatively, the transceiver of communication circuit 60 may be configured to communicate over a wired communication channel.

### Power Source 62:

In the arrangement shown, as one example, personal electronic device 14 includes a power source 62. Power source 62 is formed of any suitable size, shape, design, and/or technology and is configured to provide power to personal electronic device 14 so as to facilitate the operation of the electrical components of the personal electronic device 14. In the arrangement shown, as one example, power source 62 is formed of one or more batteries, which may or may not be rechargeable. Additionally or alternatively, in one or more arrangements, power source 62 may include a solar cell or solar panel or similar technology that may power or recharge personal electronic device 14. Additionally or alternatively, in one or more arrangements, power source 62 may be line-power that is power that is delivered from an external power source into the personal electronic device 14 through a wired connection. Any other form of a power source 62 is hereby contemplated for use.

In various arrangements, communication circuit 60 may be configured to communicate with various components of system 10 using various wired and/or wireless communication technologies and protocols over various networks and/or mediums including but not limited to, for example, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, Ultra Wideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Inputs 56:

In the arrangement shown, as one example, personal electronic device 14 includes inputs 56. Inputs 56 are formed of any suitable size, shape, design, and/or technology and are configured to facilitate user 26 input of data and/or control commands. In various different arrangements, inputs 56 may include various types of controls including but not limited to, for example, buttons, switches, dials, knobs, a keyboard, a mouse, a touch pad, a touchscreen, a joystick, a roller ball, or any other form of user 26 input.

### Display 54:

In the arrangement shown, as one example, personal electronic device 14 includes a display 54. Display 54 is formed of any suitable size, shape, design, and/or technology and is configured to facilitate display information. In one or more arrangements, display 54 may include, for example, LED lights, meters, gauges, and/or screen or monitor of a computing device, tablet, and/or smartphone. Additionally or alternatively, in one or more arrangements, the inputs 56 and/or display may be implemented on a separate device that is communicatively connected to personal electronic device 14.

### Camera 52:

In the arrangement shown, as one example, personal electronic device 14 includes one or more cameras 120. Camera 52 is formed of any suitable size, shape, design, and/or technology and is configured to facilitate taking of images to facilitate account setup, scanning or QR codes on livestock 12 tags. In the arrangement shown, as one example, camera 52 is a built-in camera sensor forming part of personal electronic device 14. Such camera sensor may include but is not limited to, for example, a charge coupled device CCD) sensor, a CMOS active pixel sensor, back side illuminated CMOS sensor, or any other type of camera sensor. Alternatively, camera 52 may be a separate device that is communicatively connected to personal electronic device 14.

### Not Limited to any Particular System or Device:

In various embodiments, personal electronic device 14 may be implemented using various different devices and/or systems to facilitate tracking, coordination, and/or control of livestock animals 12. As an illustrative example, in one or more arrangements, personal electronic device 14 may be a mobile device (such as a smartphone, tablet, or laptop). However, the embodiments are not so limited. Rather it is contemplated that personal electronic device 14 may be any other form of an electronic device (e.g., a desktop computer).

### Backend System 16:

Backend system 16 is formed of any suitable size, shape, design and is configured to communicate with personal electronic devices 14 of workers 26, perform various control processes, perform various management process, and/or implement various other modules, processes, or software of system 10. In the arrangement shown, as one example, backend system 16 includes a database 70 and a data processing system 72, among other components.

### Database 70:

Database 70 is formed of any suitable size, shape, design and is configured to facilitate storage and retrieval of data to facilitate care and treatment of livestock animals 12. In the arrangement shown, as one example, database 70 is local data storage connected to data processing system 72 (e.g., via a data bus or electronic network). However, embodiments are not so limited. Rather, it is contemplated that in one or more arrangements, database 70 may be remote storage or cloud-based service communicatively connected to data processing system 72 via one or more external communication networks.

### Data Processing System 72:

Data processing system 72 is formed of any suitable size, shape, and design and is configured to facilitate receipt, storage, and/or retrieval of information in database 70, execution of control processes 76, execution of operations coordination software 74 for configuration and backend support of system 10, and/or implementation of various other modules, processes, or software of system 10.

In one or more arrangements, for example, such data processing system 72 includes a circuit specifically configured and arranged to carry out one or more of these or related operations/activities. For example, data processing system 72 may include discreet logic circuits or programmable logic circuits configured for implementing these operations/activities, as shown in the figures, and/or described in the specification. In certain embodiments, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of instructions (and/or configuration data). The instructions (and/or configuration data) can be in the form of firmware or software stored in and accessible from a memory (circuit). Certain embodiments are directed to a computer program product (e.g., nonvolatile memory device), which includes a machine or computer-readable medium having stored thereon instructions, which may be executed by a computer (or other electronic device) to perform these operations/activities.

### Operations Coordination Software 74:

In one of more arrangements, operations coordination software 74 is configured to track statuses of livestock animals 12 and/or actions taken by workers 26 and implement processes to facilitate care for the livestock animals 12 based on the tracked statuses, for example, by controlling livestock equipment and/or prompting workers to perform various tasks.

In some various different arrangements, operations coordination software 74 may be configured to track various types of data related to the care and treatment of livestock animals 12, which may include but is not limited to, for example, various data metric and/or statistics relating to animal demographics (e.g., age, breed, and/or heredity), breeding (e.g., insemination dates, bore used, pregnancy status, length of gestation period), farrowing (e.g., litter size, stillbirths, mummies and/or complications of previous litters), biometric data (e.g., temperature, heart rate, respiratory rate, perspiration rate, and/or animal movement), medical conditions (e.g., Lameness, Mastitis, Prolapse, Anamia, Auieszkys, Eperythronzoonosis, Leptospirosis, Mycotoxicosis, Parvovirus infection, PRRS, and/or Poxoplasmosis), medical treatments, feed type and amounts of consumption, weight, environmental data and/or any other relevant data.

In some various different arrangements, operations coordination software 74 may gather data from various sources including but not limited to, observations and/or measurements input by workers (e.g., via user interface 200), reports (e.g., reports received from a veterinarian, seller, purchaser), and/or data gathered by sensors and/or automated equipment (e.g., ambient temperature sensors, air quality sensors, motion sensors, wearable sensors, automated feeders, and/or video monitoring equipment) and/or third party data sources (e.g., meteorological databases).

### Identification of High Risk Animals and Farrow Tracking:

In one or more arrangements, operations coordination software 74 is configured to evaluate the tracked data for livestock animals to identify livestock animals 12 that are at high risk for complications during farrowing. In one or more arrangements, operations coordination software 74 is configured to automatically reassess risk determination as data is updated, for example, in response to input by workers 26 and/or data received from sensors and/or automated systems.

In some various different arrangements, operations coordination software 74 may identify high risk livestock animals 12 based on various different data metrics which may include but are not limited to age, parity, previous litter sizes, length of gestation period, feed consumption, lameness or other medical condition associated with farrowing complications, stillborn and/or mummies in previous litters, stillborn and/or mummies in current litter, length of time in labor before first birth in current litter, length of time between births in current litter, and/or any other relevant factor.

As one illustrative example, in some arrangements, operations coordination software 74 may be configured to identify a livestock animal 12 as high risk if the animal satisfies one or more of a set of high risk identifies, such as:
Age greater than a threshold specified for the site; OR
First time farrowing; OR.

Greater than a threshold number of previous litters specified for the site; OR
Gestation period longer than a threshold duration specified for the site; OR
Off feed prior to farrowing; OR
Lameness or other medical condition associated with farrowing complications; OR
2 or more stillborn in a last litter; OR
2 or more stillborn on average in previous litters; OR
Average previous litter size greater than a threshold size specified for the site; OR
Insufficient dilation reported/detected; OR
1 or more stillborn in current litter; OR
Prolonged labor period before first birth in current litter; OR
Prolonged period between births in current litter.

In one or more arrangements, operations coordination software 74 may be configured to schedule, assign and/or trigger performance of various tasks based on the determined risk assessment. For example, in one or more arrangements, operations coordination software 74 may schedule, assign and/or trigger performance of tasks according to a first standard operating procedure (SOP) for high risk livestock animals 12 and schedule, assign and/or trigger performance of tasks according to a second SOP for the other lower risk livestock animals 12.

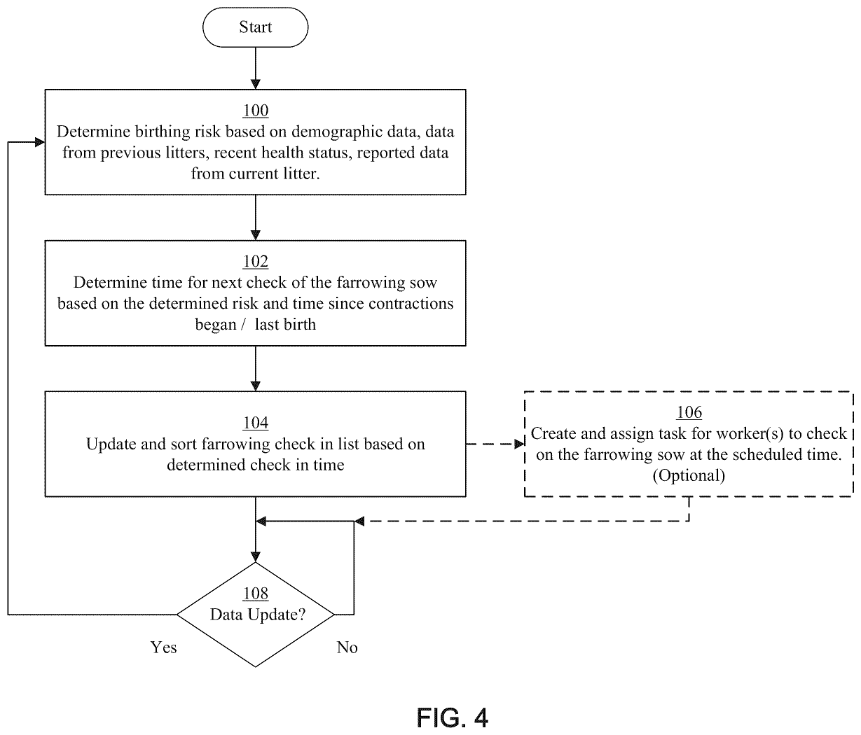

As an illustrative example, FIG. 4 shows an example process for determining risk for farrowing livestock animals 12 and scheduling check in times as a function of risk. In this example, the process begins at process block 100 when a livestock animal begins farrowing. At process block 100, the operations coordination software 74 determines birthing risk based on demographic data (e.g., age, parity, and breed), data from previous litters (e.g., litter size, stillborns, mummies, complications), recent health status, and/or data reported in current litter (stillborns, mummies, complications, labor progression), for example, as described herein. At process block 102, the process determines time for next check in on the livestock animal 12 by a worker 26 (or user 26) based on the determined birthing risk and the time since contractions began and/or time since last birth.

For instance, in some implementations, operations coordination software 74 may set check in timers for low risk farrowing livestock animals 12 with a longer duration between check ins (e.g., 30 minutes) and set check in timers for high risk farrowing livestock animals 12 with a shorter duration between check ins (e.g., 15 minutes).

While some arrangements may be primarily described with reference to assessing farrowing livestock animals 12 into two groups (high risk and low risk), the arrangements are not so limited. Rather, it is contemplated that in some various arrangements, operations coordination software 74 may quantify farrowing livestock animals 12 into any number of risk levels or groups. For instance in some arrangements, operations coordination software 74 may set even shorter check in timers for farrowing livestock animals 12 based on the number of the high risk identifiers that are satisfied.

As an illustrative example, a farrowing livestock animal 12 may be initially identified as high risk due to having an average of 3 stillborn in previous litters and operations coordination software 74 may set timers to have a worker check in on the mother every 15 minutes while farrowing. In check in following the first birth a worker may report that the birth was stillborn. In response to the new information satisfying another high risk indicator, the operations coordination software 74 may reset a timer to have check ins to occur every 8 minutes. In a later check in, a worker may report yet another stillborn. In response to the new information satisfying another high risk indicator, the operations coordination software 74 may reset a timer to have check ins to occur every 6 minutes.

In the example process shown in FIG. 4, at process block 104, the process updates and sorts a list of farrowing livestock animals for workers 26 to check in on based on the determined check in time. The list may be available for workers to view, for example, via user interface 200. Sorting of the list may permit workers 26 to easily view and prioritize which animals should be seen first. In some arrangements, operations coordination software 74 may be configured or configurable to further sort and filter based on location (e.g., livestock animals 12 in a selected barn), for the worker 26 (e.g., filtered to livestock animals 12 assigned to the worker 26, and/or any other filter or sorting criteria).

In this example process, after updating the check in list, the process halts at decision block 108 until data is updated, for example, by data received from sensors 20 and/or data input by workers 26 (e.g., via user interface 200). When data is updated, the process returns back to process block 100 and the process is repeated. In this manner risk and check-in timers are dynamically updated on the fly as new data is made available.

In addition to scheduling check ins for farrowing livestock animals 12, in some arrangements, operations coordination software 74 may be configured to create and assign tasks to workers 26 to perform the scheduled check ins. For example, in some implementations of the example process shown in FIG. 4, after process block 104 the process may proceed to process block 106. At process block 106 operations coordination software 74 creates and assigns a task to one or more workers to perform the check in on the livestock animal 12 at the scheduled time. In addition to scheduling and assigning tasks to generally check in on farrowing livestock animals 12, in some arrangements, operations coordination software 74 may be configured to provide and/or assign workers performing check ins a set of specific tasks to be performed. In some various arrangements, operations coordination software 74 may dynamically adjust check in tasks to be performed based on, for example, risk of the livestock animal 12, how farrowing is progressing, observances reported, and/or detected complications. Following process block 106, the process proceeds to decision block 108, where the process waits for an update to the data as previously described.

### Identification of Complications:

In some arrangements, operations coordination software 74 is configured to identify when certain complications occur in farrowing and alert a veterinarian and/or suitably trained worker to provide suitable treatment to address the complication. In some various arrangements, complications may be detected by a worker (or sensors or automated equipment) reporting certain observances in check ins that alone, in combination, and/or in combination with data of the livestock animal 12 stored by backend system 16, indicate that a complication may be present. In one or more arrangements, operations coordination software 74 may utilize an image recognition system to monitor dilatation, contractions, birthing events, and/or other events and/or factors from a video feed from a camera positioned in a farrowing crate. Additionally or alternatively, in some arrangements, a worker may report recognized complication directly to operations coordination software 74 using, for example, user interface 200. In one or more arrangements, operations coordination software 74 may utilize audio captured by a microphone in a crate to detect when a farrowing livestock animal 12 or newborns are in distress or are experiencing notable events.

In one or more arrangement, operations coordination software 74 is configured to permit a site operator to customize criteria for identification of high risk sows, actions to be performed for various levels of risk, criteria for identification of complications, and/or actions to be performed when complications are identified.

In some various arrangements, operations coordination software 74 is configured to automatically trigger one or more actions when complications are identified. Such actions may include but are not limited to for example, prompting control processes 76 to operate automated livestock equipment (e.g., engaging fan or adjusting climate controls to cool animal 12), prompting worker(s) to administer certain treatments and/or perform certain tasks, and/or sending a message to veterinarian.

### Identification of Overpopulated and Underpopulated Litters for Fostering:

In one or more arrangements, operations coordination software 74 is configured to track the number of functional tits reported for farrowing livestock animals 12. After birthing, operations coordination software 74 may be configured to evaluate the size of the surviving litter and numbers of functional tits to determine which crates have excessive newborns and which crates can accommodate additional newborns to assist in relocation of newborns for fostering. In one or more arrangements, operations coordination software 74 is configured to provide a list of farrowing sows/crates indicating remaining capacity or excess capacity for nursing of newborns to facilitate easy review by workers 26. The list may be available for workers to view, for example, via user interface 200. In some arrangements, operations coordination software 74 may be configured or configurable to further sort and filter, for example, based on capacity, location, and/or any other filter or sorting criteria. In some arrangements, operations coordination software 74 may additionally or alternatively include an interface for a worker to easily update data in the system when livestock animals are moved (e.g., when newborns are moved from an overcrowded farrowing create to another with available capacity).

### Split Sucking Management:

In one or more arrangements, operations coordination software 74 is configured to track and coordinate split suckling of piglets to ensure each piglet has adequate access to the mother sow for nursing. For example, in one more arrangements, coordination software 74 may be configured to schedule and assign various tasks to users to facilitate split suckling. For instance, similar to assignment of tasks for farrow tracking, coordination software 74 may set periods of time for each group of piglets to be separated or nursing and set timers for users to swap the groups of piglets. By tracking and coordinating split suckling tasks, distribution of colostrum among piglets can be optimized.

### Task Assignment and Oversight:

As previously mentioned, in some arrangements, operations coordination software 74 is configured to or is configurable to automatically schedule and/or assign tasks in response to updates to livestock data, determined risk assessment, identification of complications, and/or other events. For example, in one or more arrangements, operations coordination software 74 may be configured to automatically create and assign tasks for check in on farrowing livestock animals 12 before expiration of the respective check in timers. For instance, in some arrangements, operations coordination software 74 may be configured to create and assign a task to check in on a farrowing livestock animal 12 if check in is not performed by any worker within 5 minutes of expiration of the timer (or other threshold time that may be set by a site operator or other authorized user).

In some various different arrangements, operations coordination software 74 may utilize various means or methods to determine assignment of tasks. For example, in some arrangements, operations coordination software 74 may be configured to select a worker 26 for assignment of a task based on current backlogs of workers 26 (e.g., to balance workload). Additionally or alternatively, in some arrangements, operations coordination software 74 may be configured to select a worker 26 based on geolocation of the workers 26 and geolocation of the task to be performed. For example, for time sensitive tasks such as farrowing check ins, selection of workers 26 close to the livestock animal 12 to be check may help ensure the check in is completed as soon as possible. However, the arrangements are not so limited. Rather, it is contemplated that in some arrangements, operations coordination software 74 may be configured to select a worker 26 for assignment of tasks using any suitable criteria, method, or mean.

In one or more arrangements, operations coordination software 74 is configured to additionally or alternatively permit workers 26 to create and schedule various tasks to be performed, for example, via user interface 200. In one or more arrangements, when a new task is created, a worker 26 may schedule the task as a one-time event or schedule the task to be performed on a reoccurring basis. In one or more arrangements, when a new task is created, the task may be an unassigned task (e.g., for performance by any worker as time permits) or may be assigned to one or more specific persons or group. In one or more arrangements, tasks may only be assigned by workers who are authorized to delegate tasks (e.g., a manager or a team leader).

In one or more arrangements, operations coordination software 74 is configured to provide an interface for workers 26 to easily view tasks assigned to them and/or tasks that are unassigned and update status of such tasks (e.g., not started, in progress, and/or completed). In one or more arrangements, tasks of workers 26 are sorted by deadline by default. However, in one or more arrangements, operations coordination software 74 is configured to permit workers 26 to sort and filter tasks based on location (e.g., tasks for a selected barn), assigned worker/group, by livestock animal 26, and/or any other filter or sorting criteria.

### Performance and Compliance Tracking:

In one or more arrangements, operations coordination software 74 is configured to track status of tasks and permit a managers or other authorized user to review status and/or other data for tasks.

In one or more arrangements, operations coordination software 74 is configured to track whether tasks were completed prior to the specified deadlines or how long past deadlines were tasked overdue before completion. In one or more arrangements, operations coordination software 74 is configured to permit a user to sort and/or filter statistics related to worker performance of tasks, for example to review performance for specific workers 26, groups of workers 26, category of tasks, location, specific livestock animals 12 or any other filter or sorting criteria. As an illustrative example, a manager may filter task performance statistics to view statistics for farrowing check ins that exceeded the deadline by a specified threshold (e.g., 1 minute), for example, to identify workers 26 or groups whose performance of assigned tasks is placing farrowing livestock animals 12 and newborns at risk.

In some arrangements, operations coordination software 74 may be configurable by a site operator or authorized user to track whether workers 26 performance of tasks and/or other actions is in compliance with a set of compliance policies. In some various arrangements, operations coordination software 74 may consider a number of various different factors in determine whether performance of a task and/or action is in compliance with the compliance policies. For example, in the context of scheduled birthing observations, compliance policies may factor in a combination of whether a sow and litter could have been supervised during working hours, the frequency of check ins, the number of newborns per check in, the number of sows farrowing per active caregiver, and/or the duration of the birthing process. In one or more arrangements, operations coordination software 74 is configured to use a default set of compliance polices but permits a site operator or other authorized user to customize the compliance polices to suit the particular needs of the livestock operation.

In one or more arrangements, operations coordination software 74 is configurable by a site operator or other authorized user to automatically communicate an alert to a site operator when a threshold level of non-compliance with compliance polices is identified. For example, a site operator may configure operations coordination software 74 to communicate an alert in response to a worker's repeatedly failing to meet deadlines for check in on farrowing livestock animals 12. As another example, a site operator may configure operations coordination software 74 to communicate an alert in response to a check in task for a farrowing livestock animal 12 exceeding the scheduled check in time by a threshold amount of time (e.g., 5 minutes). However, the arrangements are not so limited. Rather, it is contemplated that in one or more arrangements, operations coordination software 74 may be configured by a site operator or other authorized user to provide alerts based on any number of different criteria or occurrence of events.

### Animal-Level Compliance Tracking

In one or more arrangements, operations coordination software 74 may be configured (e.g., by a site operator or other authorized user) to track one or more metrics to document compliance with a set of policies for individual animals. In some various arrangements, such set of policies may be configured to track compliance with on-site policies, operational requirements for insurance policies, requirements for certification standards (e.g., USDA organic), and/or government regulations, among other use cases.

As an illustrative example, California Proposition 12 regulations requires 24 square feet of usable floor space per animal to all gilts at breeding, weaned sows, and gestating gilts and sows. However, this requirement does not apply to cull sows. The requirement also does not apply when sows are being transported, used in research, individually treated, immediately prior to slaughter, 5 days prior to the expected farrowing date, and when nursing piglets. Sows have not been raised in compliance with Proposition 12, cannot be sold within California.

In one or more arrangements, coordination software 74 is configured with a set of compliance policies that, when enabled, automatically track status of sows and determine if husbandry of the sow has been in compliance with Proposition 12. Such automated tracking may permit compliant sows to be easily determined when culling so they may be so identified and sold at a premium. Conversely, non-compliant sows may be automatically identified and diverted from a sale subject to Proposition 12.

Additionally or alternatively, in some arrangements coordination software 74 is configured track status of sows and identify when a scheduled action or inaction may lead to violation of the set of compliance policies. For example, in one or more arrangements, coordination software 74 is configured to track location of sow and document that a valid exception applies when sows are not in their primary 24 square sq foot/sow living space. For example, in some arrangements, coordination software 74 may be configured to prompt a user to verify which exception applies whenever a sow is moved from the primary living space. Additionally or alternatively, in some arrangements, coordination software 74 may be configured to re-prompt a user to reverify an exception remains valid if the sow is not returned to the primary living space within a threshold period of time. As an illustrative example, in some arrangements, when illness is selected as an exception for a sow, coordination software 74 may be configured to automatically prompt a user to recertify that the sow remains ill if not returned to the primary living space within a threshold number of days.

The configurability of system 10 to track compliance with certification standards, regulations, or other sets of policies may help to promote and reenforce such standards, regulations, and/or policies while also enable detailed compliance reporting to facilitate auditing. This feature supports strategic decision-making by providing insights into regulatory alignment and operational risks, potentially identifying areas for improvement that are critical under the new legal frameworks.

### Control Processes 76:

In some various arrangements, data processing system 72 is configured to implement one or more control processes 76 to initiate performance of various actions in response to operations coordination software 74, tracked data on livestock animals 12, and/or data from sensors 20 satisfying certain conditions. For example, in one or more arrangements, control processes 76 may be configured to, and/or prompted by operations coordination software 74 to, automatically adjust operation of automated livestock equipment 22 in response to changes in status of livestock animals 12. For instance, in one or more arrangements, control processes 76 may be configured to, and/or prompted by operations coordination software 74 to, automatically adjust operation of an automated feeder 22 of a livestock animal for gestation and/or farrowing based on status of the livestock animal 12. For instance, in one or more arrangements, control processes 76 may cause an automated feeder 22 to switch to dispensing a certain feed and/or begin to increase amounts of feed dispensed after a certain period of time following insemination (e.g., 15 days) and/or after status of the livestock animal 12 is updated to a pregnant status. Additionally or alternatively, in one or more arrangements, control processes 76 may similarly cause an automated feeder 22 to switch to dispensing another type of feed and/or adjust feed amounts that is optimized for nursing once status of the livestock animal 12 is updated to indicate farrowing has begun. Additionally or alternatively, in one or more arrangements, control processes 76 may similarly cause the automated feeder 22 to switch back to a typical feed and feed amounts after newborns being nursed by the livestock animal 12 are weened.

As another example, in one or more arrangements, control processes 76 may be configured to, and/or prompted by operations coordination software 74 to, automatically adjust one or more environmental control devices (e.g., fans, actuated vents, heating devices, and/or cooling devices) prior to birthing to provide an optimal environment to increase newborn survival rate. As previously noted, in the context of farrowing swine, failure to provide newborn piglets with sufficient external heat may lead to the death of some piglets from chilling, starvation, and disease. In lieu of an external heat source piglets may lie against the sow for warmth, this increases the chances of the sow rolling over and suffocating or crushing the piglets. Additionally or alternatively, in one or more arrangements, control processes 76 may similarly adjust environmental control devices after weening to turn off the external heating device and/or provide a lower normal temperature for the SOW until weening is completed and the SOW is removed from the farrowing crate.

However, the arrangements are no limited to these illustrative examples. Rather, it is contemplated that in some various arrangement, control processes 76 may be adapted to operate and/or adjust any automated system or device that may be useful in livestock operations.

### Customizable Operation:

In one or more arrangements, operations coordination software 74 is configured to permit a site operator or other authorized user to customize the criteria and/or conditions use to trigger performance of various actions when satisfied and/or customize the actions performed when the criteria or conditions are satisfied. In some various different arrangements, criteria and/or conditions may be specified as functions of various data metrics including but are not limited to, for example, threshold values, states, or statuses of livestock data, sensor, equipment and/or devices, and/or any other data maintained by backend system or third party systems. In some various different arrangements, criteria and/or conditions may be specified as Boolean states or functions such data metrics (e.g., threshold value triggers), and/or Boolean logic functions function of a combination of Boolean states and/or Boolean functions. However, embodiments are not so limited. Rather, it is contemplated that in some various embodiments, criteria and/or conditions may be specified in any configuration, arrangement, format, or structure.

### Data Analytics and Machine Learning:

In some example arrangements, data processing system 72 of backend system 16 is configured to perform data analytics to derive various additional data metrics from the tracked data. Additionally or alternatively, in some arrangements, data processing system 72 may be configured and arranged to monitor, learn, and modify one or more features, functions, and/or operations of the system.

For instance, in one or more arrangements, data processing system 72 may be configured to monitor and/or analyze data stored in database 70 and/or operation of system 10. As one example, in one or more arrangements, data processing system 72 may be configured to analyze the data and learn, over time, data metrics indicative of various areas of opportunity, prioritize tasks, optimize connected technologies, genetically select breeding stock, among other actions. In one or more arrangements, the data processing system 72 may be configured to provide recommendations on workflows, ideal personnel for a task, and/or guidance on performing tasks for optimal care and financial outcomes based on the analytics. As another example, in one or more arrangements, data processing system 72 may be configured to use tracked data to improve algorithms, criteria, and/or processes used by system 10, for example, for evaluating birthing risk and/or identification of complications.

Such learning may include, for example, generation and refinement of classifiers and/or state machines configured to map input data values to risk assessment, complication assessment, or other outcomes of interest or to operations to be performed by the system 10. In various embodiments, analysis by the data processing system 70 may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof. In one or more arrangements, operations coordination software 74 utilize data analytics and artificial intelligence processes to revolutionize data accessibility within the swine industry provide an AI-driven user platform, enabling an unprecedented view into both animal health and human-animal interactions. This holistic observation capability can provide insights into the entire operational chain-from individual animal health to broader production outputs and workforce interactions. Such comprehensive data access enables seamless connection with precision solutions, big data analytics, and commodity trading.

For example, in one or more arrangements, coordination software 74 is configured to evaluate the productivity of an animal against its health records. If an animal consistently exhibits high output but also frequent illness, the coordination software 74 may recommend its sale to optimize economic returns against the costs of care and treatment. This is just one way in which coordination software 74 may be configure to utilize data analytics and artificial intelligence processes to enhance decision-making processes.

As another example, in one or more arrangements, coordination software 74 is configured to data analytics and/or machine learning to diagnose environmental impacts on animal health. For instance, in scenarios where piglets may be suffering due to apparent conditions such as a cold environment, coordination software 74 can pinpoint more complex causative factors, like a malfunctioning fan, which might be the real issue rather than the temperature itself. This depth of analysis is possible because coordination software 74 can integrates data from every aspect of a farm's operations, enabling a comprehensive evaluation that other products simply cannot match.

In some various arrangements, by accessing and analyzing every component of the farm environment, data analytics and/or machine learning capabilities of coordination software 74 can facilitate for a reverse engineering approach to problem-solving. For instance, rather than merely identify symptoms, coordination software 74 may be configure to traces symptoms back to their root causes, offering precise diagnoses. This backtracking approach ensures that interventions are not just reactive but proactive, addressing the underlying factors of observable issues.

### User Interface 200:

In the arrangement shown, as one example, system 10 includes a user interface 200. User interface 200 (GUI 200) is formed of any suitable size, shape, design, and/or technology and is configured to facilitate tracking, coordination, and/or control of livestock operations. In one or more arrangements, as one example, user interface 200 may be provided by, for example, execution of a local application on personal electronic device 14. Additionally or alternatively, in one or more arrangements, user interface 200 may be provided by web-based application executed in a web browser of the personal electronic device 14. Such web application may be, for example, a web portal hosted by a web server on backend system 16 or by a third-party service provider.

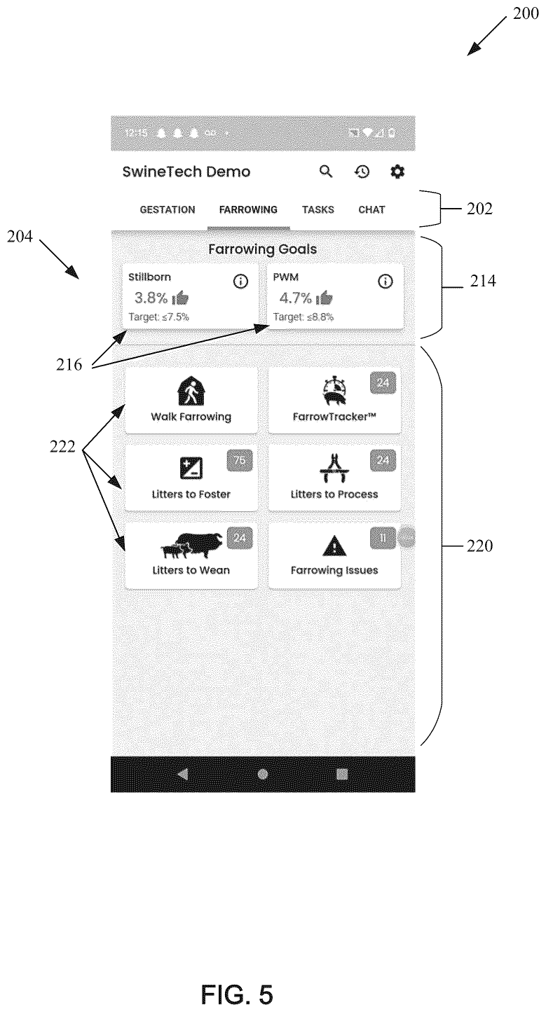

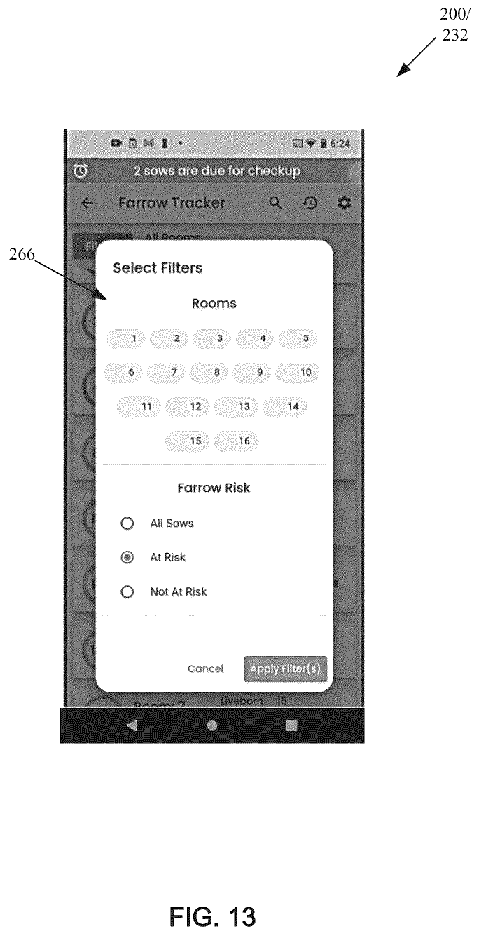

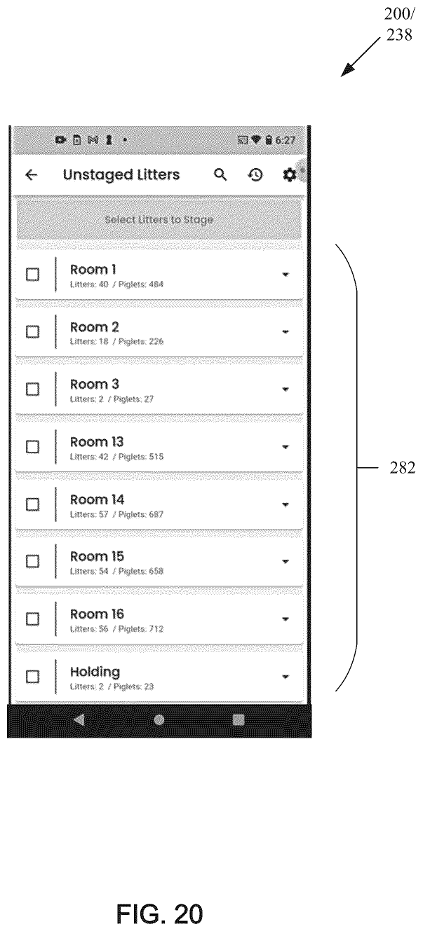

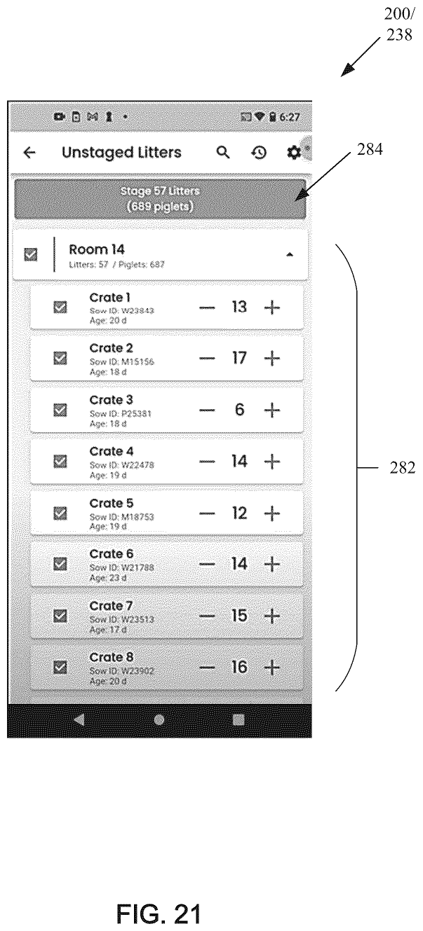

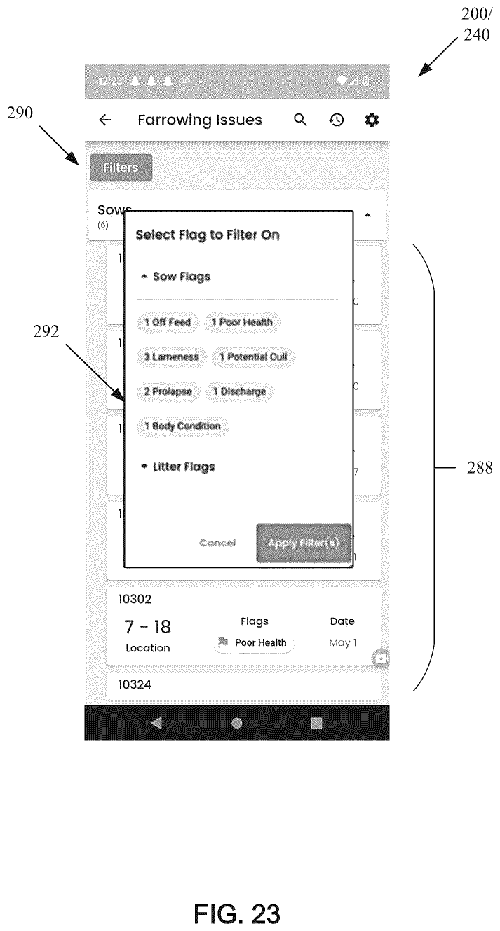

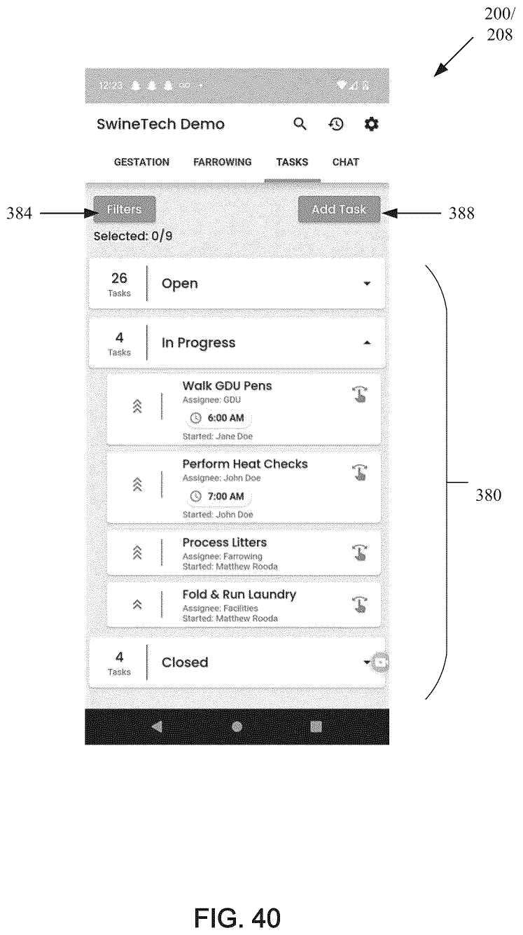

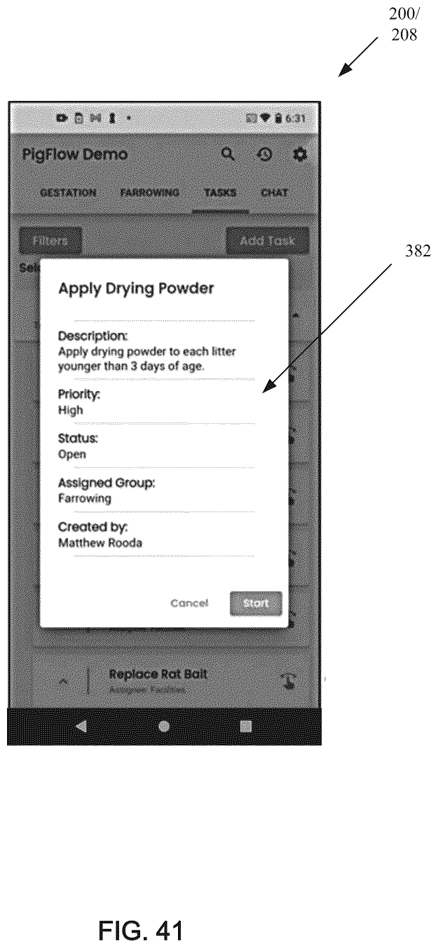

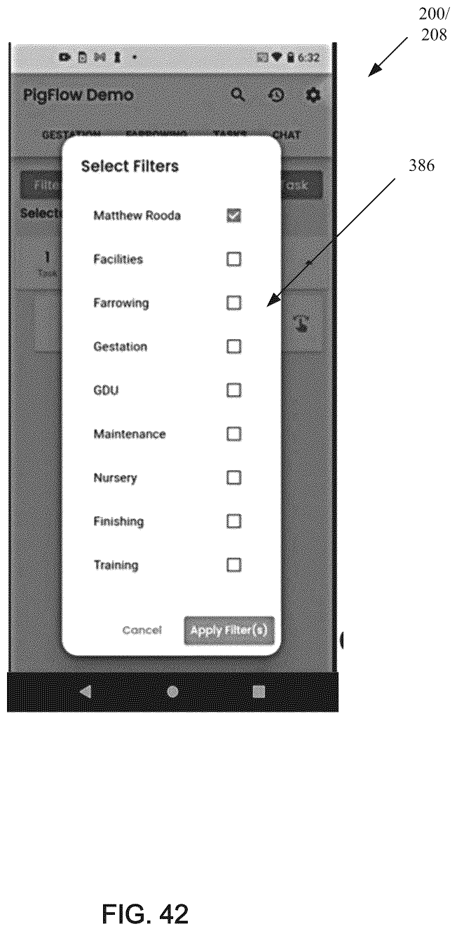

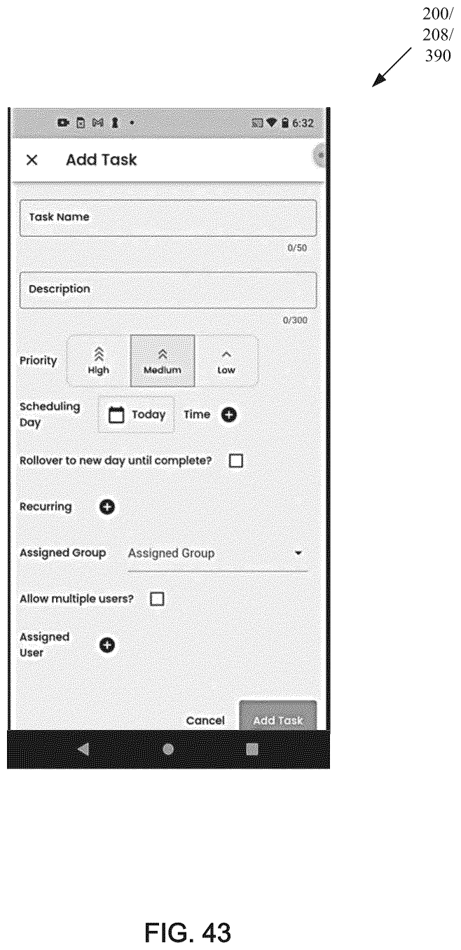

FIGS. 5-44 show screenshots of an example graphical user interface configured to facilitate tracking, coordination, and/or control of livestock operations by user 26 as described with reference to one or more of the arrangements described herein and the brief description of the figures. In this illustrative example, the graphical user interface is tailored for the care and treatment of swine, however, in some various arrangement the example graphical user interface may be adapted for care and treatment of any type of livestock animal 12.

In this example graphical user interface, is functionally organized into a set of tabs 202, which provide access to a farrowing dashboard 204 a gestation dashboard 206, a task dashboard 208, and a chat interface 210. However, the arrangements are not so limited. Rather, it is envisioned that in various different arrangements may include any number of various dashboards and/or interfaces.

### Farrowing Dashboard 204:

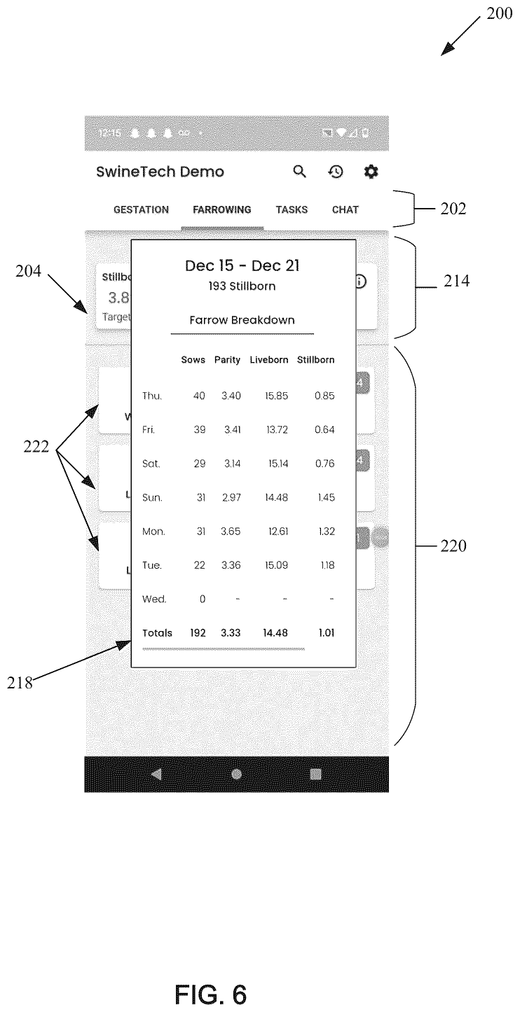

FIGS. 5-23 show screenshots of the farrowing dashboard 204, in accordance with one or more arrangements. In this example, farrowing dashboard 204 displays some cumulative farrowing statistics in an upper panel 214. More specifically, in this example, upper panel 214 includes tiles 216 showing current actual rate and target rates of stillborns as well as current actual rate and target rates of pre-weaning mortality (PWM). In this example arrangement, if a user clicks on one of the tiles 216, a pop-up window 218 is displayed showing additional statistics. FIG. 6 shows an example pop-up window 218 that may be displayed. In this example, the pop-up window 218 shows the number of sows that have farrowed along with statistical rates of parity, average liveborn, and average stillborn by day of the week. However, in various different arrangements, the tiles 216 in upper panel 214 and/or pop-up window 218 may be adapted to provide various additional or alternative information relating to farrowing and/or in various additional or alternative formats.

In this example, farrowing dashboard 204 provides tiles 222 in a lower panel 220 that provide access to a set of tools as well as some high level summary information. In this example, farrowing dashboard 204 includes tiles 222 for a Walk Farrowing tool 230, a Farrow Tracker tool 232, a Litters to Foster tool 234, a Litters to Process tool 236, a Litter to Wean tool 238, and a Farrowing Issues tool 240. In this example arrangement, a worker 26 may navigate to each tool by simply clicking on the respective tile 222 for the tool. However, the arrangements are not limited to these specific tools. Rather, it is envisioned that in some various arrangements, farrowing dashboard 204 may be adapted to have any number of additional or alternative tools. For example, in one or more arrangements, farrowing dashboard may provide access to an Early Pig Care tool 242 configured to facilitate split suckling and other care for newborn piglets.

### Walk Farrowing Tool 230:

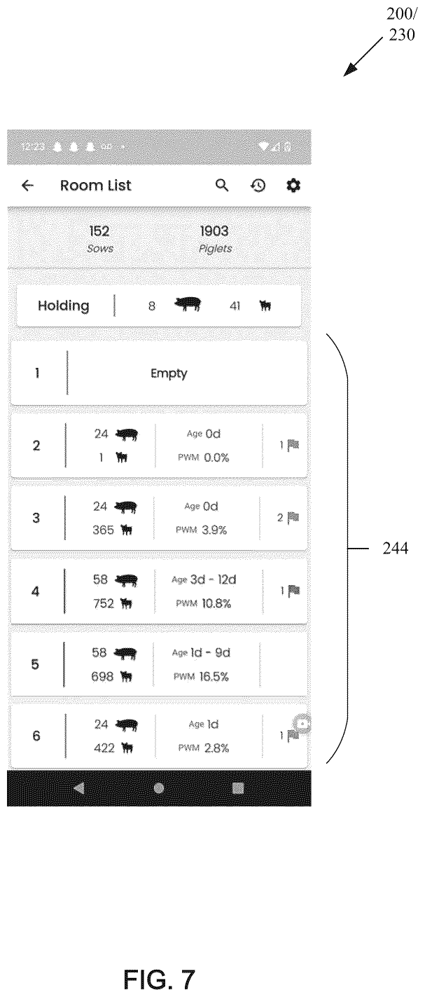

FIG. 7 shows an example screenshot of Walk Farrowing tool 230, in accordance with one or more arrangements. In this example arrangement, Walk Farrowing tool 230 provides a summary of farrowing information organized as a virtual walk through by a worker 26. For instance, in this example, Walk Farrowing tool 230 shows a list 244 of rooms of a farm with the list ordered as rooms would be encountered if a worker 26 were to walk the farm. In this example, the entry for each room in the list 244 indicates how many sows and newborn piglets are in each room, mortality rate, age range of newborn piglets, and number of tasks and/or issues in that room.

If a worker 26 were to virtually walk the farm in this example, they would see that room 1 has no sows and can be loaded with other sows. Rooms 2 and 3 each have 24 sows and a number of piglets that are less than a day old. In this example, a worker would see that room 2 has one task or issue to be addressed and room 3 has 2 tasks or issues to be addressed. Moving past rooms 2 and 3, a worker 26 can see room 4 has 58 sow and 365 piglets ranging from 3 to 12 days old and there is 1 task or issues to be addressed. Moving past room 4, the worker 26 can see room 5 has 58 sows and 752 piglets ranging from 1 to 9 days old. In this example, the worker 26 can see that there are no tasks or issues to be addressed in room 5 so the worker can skip room 5 at this time if there are other tasks and/or issues to be addressed. In this manner, the worker 26 can scroll through the list as they are actually walking through the barn and have relevant information immediately available to know what work needs to be performed. This organization and interaction is simple, intuitive, and provides an easy way to enter information. For instance, a worker 26 does not need to scan or enter a sow ID. Rather, the worker 26 can just scroll as they move through the farm. Additionally or alternatively, in some arrangements, Walk Farrowing tool 230 may use geolocation of the worker 26 to automatically update the list to show information for nearby rooms wherever the worker 26 may be located on the site.

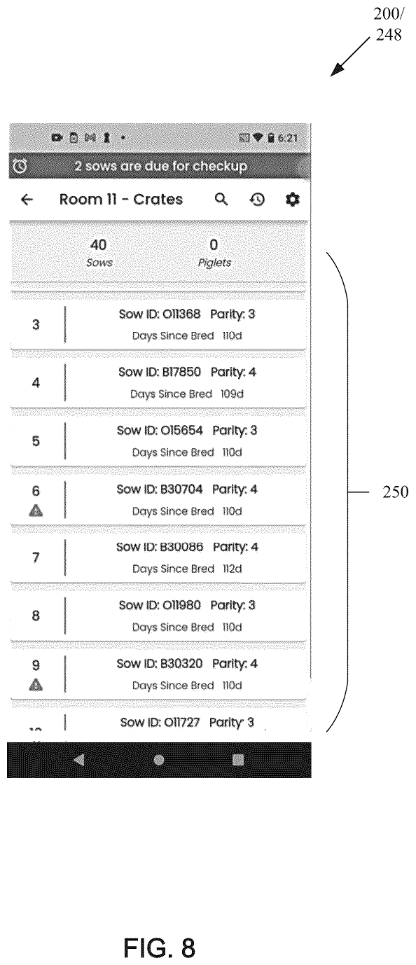

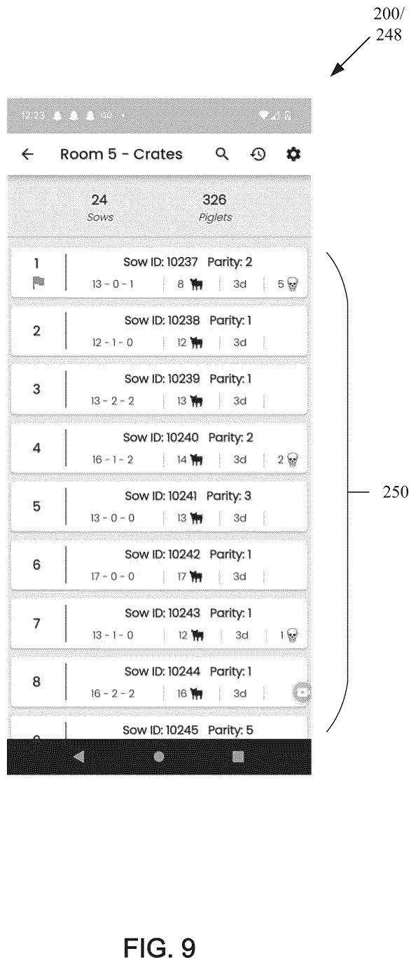

In one or more arrangements, a worker 26 may click on a room to present an interface 248 to view detailed information for sows in the room. FIG. 8 shows a screenshot of an example interface 248 displaying information for a number of crates with sows ready for farrowing. In this example, interface 248 provides a scrollable list 250 of crates in the selected room. In one or more arrangements, the list 250 can be customized to the room so that crates are listed in the order a worker 26 would encounter the crates as they walked the room. In this example, the entry for each crate in the list 250 indicates the ID for a sow in the crate (if any), the parity, and days since the sow was bred so the worker 26 can have an idea of how close the sow is to farrowing. In this example arrangement, the list 250 provides a warning sign next to the crate number for sows (e.g., sows in crates 6 and 9) that have been identified by operations coordination software 74 as high risk. FIG. 9 shows another screenshot of the example interface 248 displaying information for a number of crates that have piglets. For crates that have piglets the entry in the list 250 shows the numbers of liveborn piglets, stillborn piglets and mummies, the total number of piglets, days of age, and number of deaths.

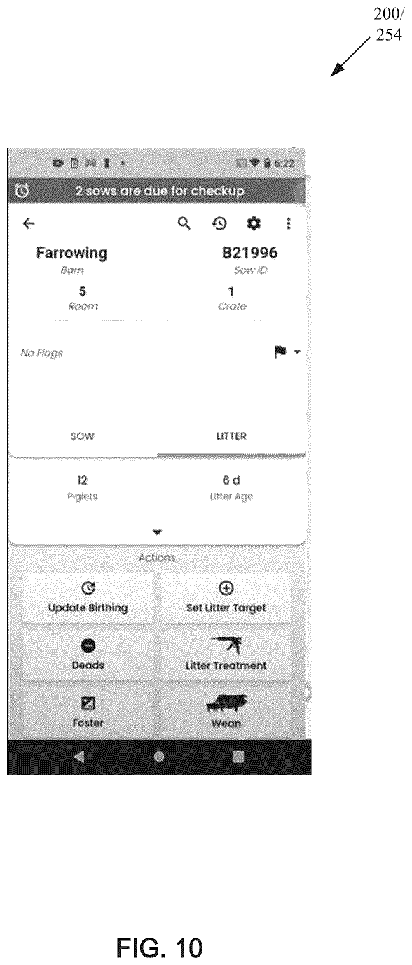

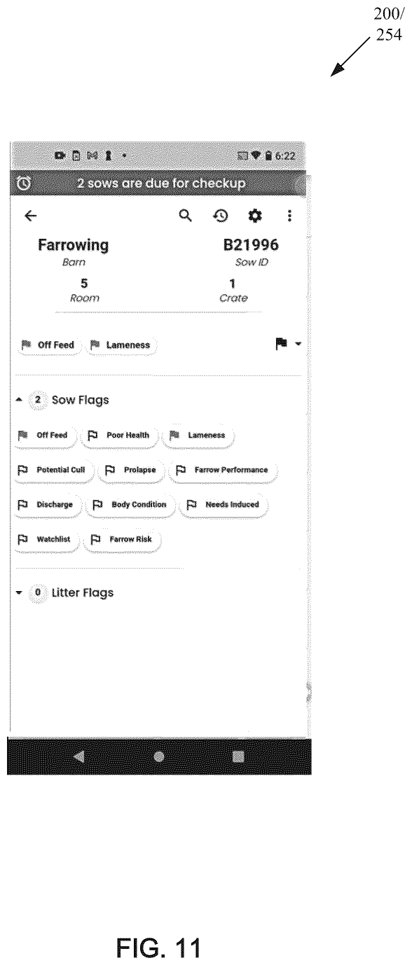

In one or more arrangements, a worker 26 may click on a crate in the list 250 to present an interface 254 to edit information for the sow and/or piglets in the crate. FIG. 10 shows a screenshot of an example interface 248 editing information for a crate. In this example, a worker 26 can use interface 254 to record a number of events to update information for a sow and/or piglets including but not limited to, for example, updating birthing info, adjusting litter targets, recording a dead if discovered, flagging a sow for various conditions, recording treatments, recording foster relocations of piglets, recording transfer of piglets for weening, and/or any other information. FIG. 11 shows a screenshot of the example interface 248 presenting a number of flags that may be selected by a worker 26 with flags selected for being off feed and lameness. However, the arrangements are not limited to the particular flags and information shown and discuss herein. Rather, it is envisioned that interface 248 may be adapted to permit a worker 26 to update and/or record any type of information.

### Farrow Tracker Tool 232:

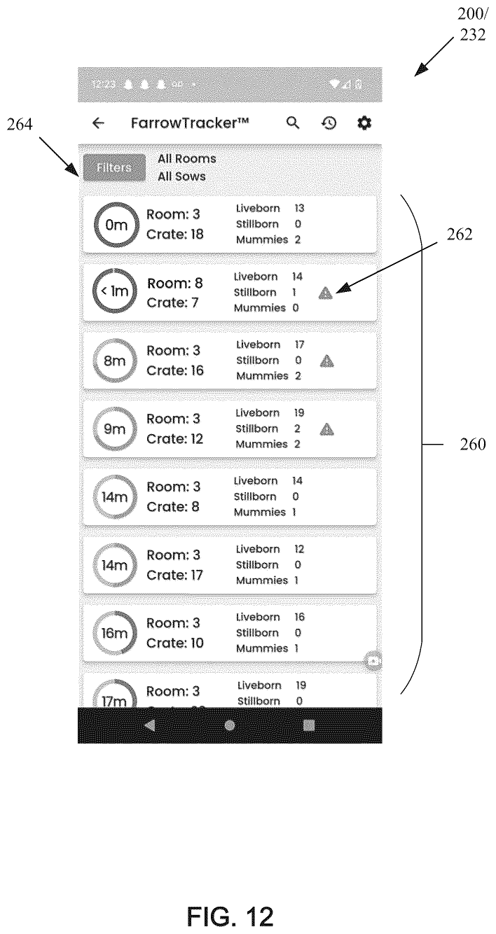

FIG. 12 shows a screenshot of an example Farrow Tracker tool 232, in accordance with one or more arrangements. In one or more arrangements, Farrow Tracker tool 232 allows workers 26 to easily view information on all the sows that are currently farrowing and how much time is left until operations coordination software 74 has scheduled for a worker to check in on each sow. In the example shown in FIG. 12, Farrow Tracker tool 232 provides a scrollable list 260 of all sows currently farrowing. In this example, the list is sorted by the time remaining on the check in timers set by operations coordination software 74. In the example shown in FIG. 12, you can see that two sows at the top of the list 260 are due for a check in. In some arrangements, user interface 200 may additionally or alternatively be configured to push a notification or otherwise provide an alert with a check in timer has expired. In this example arrangement, Farrow Tracker tool 232 provides a warning icon 262 to indicate sows that were determined by operations coordination software 74 to be at high risk.

In this example arrangement, a worker 26 may filter the list 260 by clicking button 264 to bring up filter interface 266 in a pop-up window. In this example, filter interface permits a worker 26 to filter by room or determined risk level of the sows. However, the arrangements are not so limited. Rather, as previously discussed, in some arrangements, user interface 200 may permit workers to sort and/or filter based on location (e.g., building or room), by the worker 26 (e.g., filtered to sows assigned to the worker 26), by risk, and/or any other filter or sorting criteria).

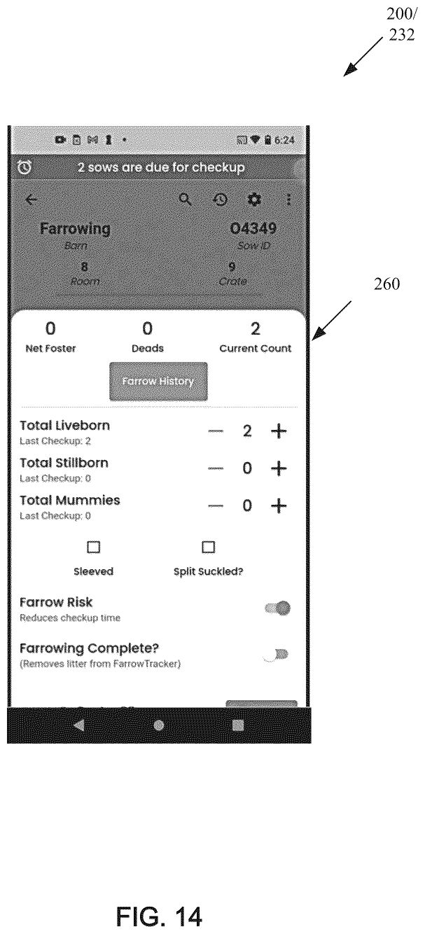

In one or more arrangements, when it is time to perform a check-in of a sow, a worker 26 may easily select the sow from the list to invoke a check in interface 268 to facilitate reporting and update of information. FIG. 14 shows a screenshot of an example check in interface 268, in accordance with one or more arrangements. In this example, the check in interface 268 permits a worker 26 to review farrow history of the sow, adjust records for total liveborn, total stillborn, and total mummies in the current litter, report when the sow is sleeved, report if split suckling was performed, view risk status or manually mark a sow as high risk, and/or record when farrowing is complete. However, the arrangements are not so limited. Rather, it is contemplated that in some various arrangements, check in interface 268 may be configured to permit workers to report and/or update various alternative and/or additional information.

### Litters to Foster Tool 234 and Litters to Process Tool 236:

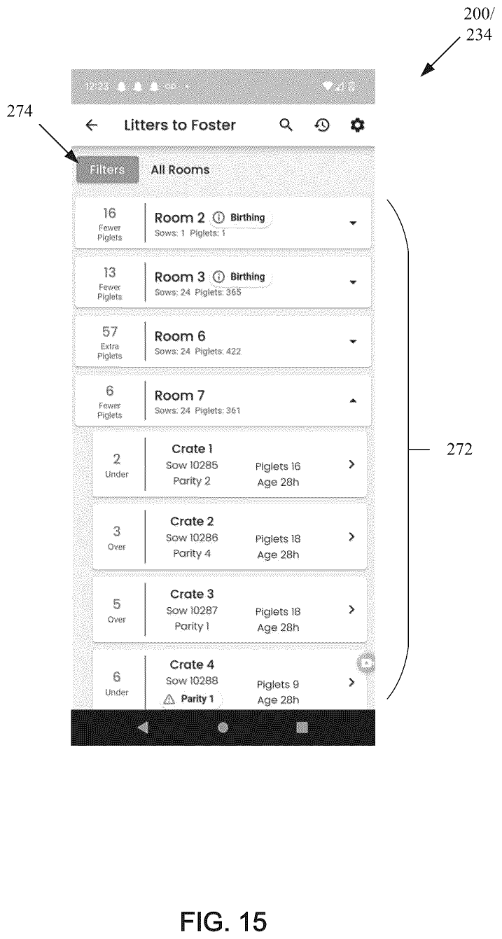

FIG. 15 shows a screenshot of an example Liters to Foster tool 234, in accordance with one or more arrangements. In one or more arrangements, Liters to Foster tool 234 allows workers 26 to easily view nursing capacity of crates and/or rooms and update information for transfer of piglets for fostering. In this example, Liters to Foster tool 234 provides a scrollable list 272 of litters organized by room. In this example, the list 272 indicates for each room, birthing status, the number of sows, the number of piglets, and the number of piglets in excess of nursing capacity and/or remaining nursing capacity for additional piglets. In this example, the list 272 is expandable to view nursing capacity of crates in each room. In this example, the list 272 indicates for each crate an ID of the sow, parity, the number of piglets, age of the piglets, and nursing capacity. In this example arrangement, a worker 26 may filter the list 272 by clicking button 274 to filter the litters in a similar manner as described with reference to filtering with Farrow Tracker tool 232.

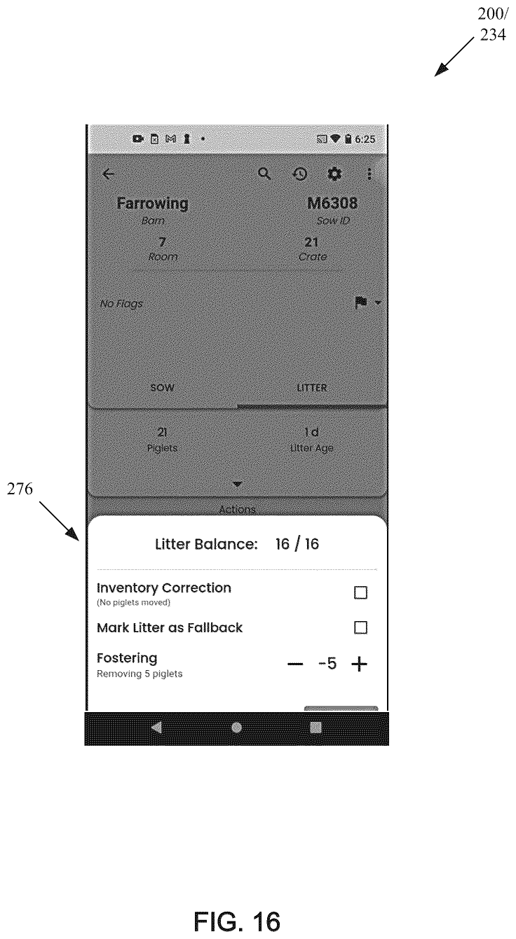

The ability to easily review nursing capacity of rooms and/or crates allows fostering to be performed more quickly and easily. For example, reviewing capacity at a room level a worker 26 can easily determine which rooms required a nurse sow. Reviewing capacity at crate level a worker 26 can easily determine how to rebalance creates so no crates are over capacity. In this example arrangement, a worker may click on a crate in list 272 to bring up a litter balance interface 276 to facilitate correction of piglet inventory or fostering of excess piglets. FIG. 16 shows a screenshot of an example litter balance interface 276, in accordance with one or more arrangement. As shown in FIG. 16 a worker 26 can easily increase or decrease the number of piglets to be fostered for litter balancing. In one or more arrangements, operations coordination software 74 may be configured to automatically create and/or assign one or more tasks to perform foster transfers after balancing is completed.

In some arrangements, litter balance interface 276 is configured to only permit fostering after piglets have reached a threshold age (e.g., 24 hours). In one or more arrangements, operations coordination software 74 permits a site operator or other authorized user to customize such threshold time for fostering.

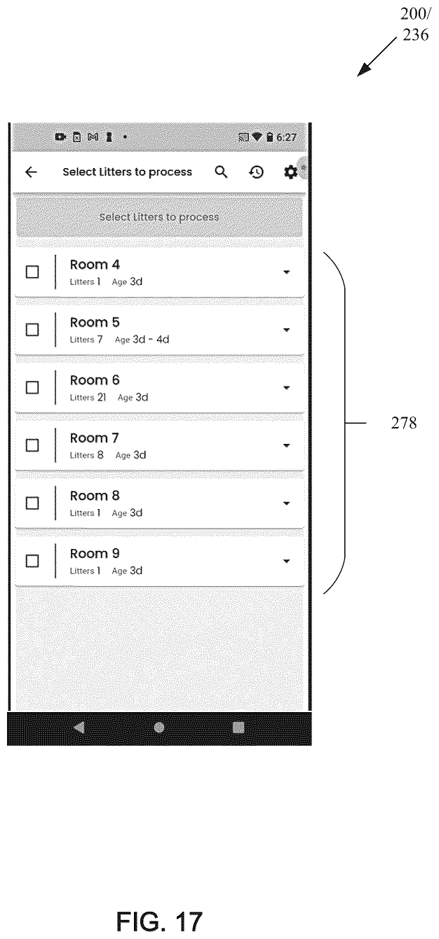

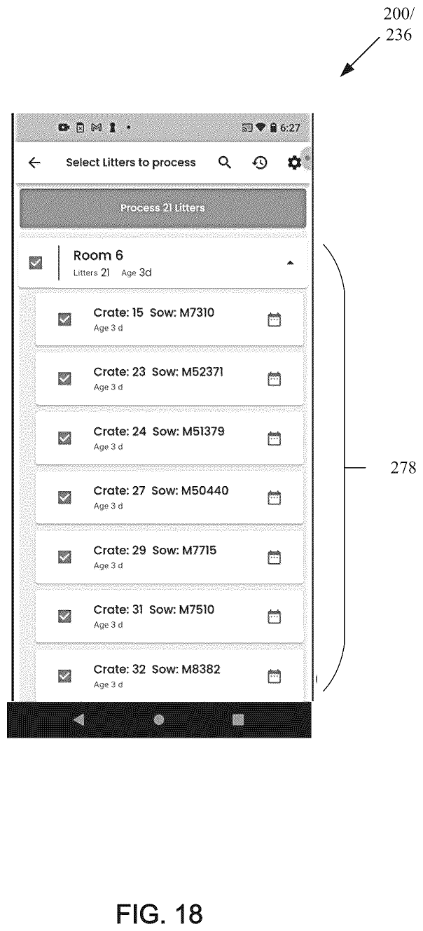

Additionally or alternatively, in some arrangements, litter balance interface 276 is configured to only permit fostering after a crate has been selected or processing by a site operator or other authorized user, for example, using Litters to Process tool 236. FIGS. 17 and 18 show some screenshots of an example Litters to Process tool 236, in accordance with one or more arrangements. In this example arrangement, Litters to Process tool 236 provides a collapsible list for a worker 26 to browse rooms and crates to select/deselect litters to process.

### Litters to Ween Tool 278:

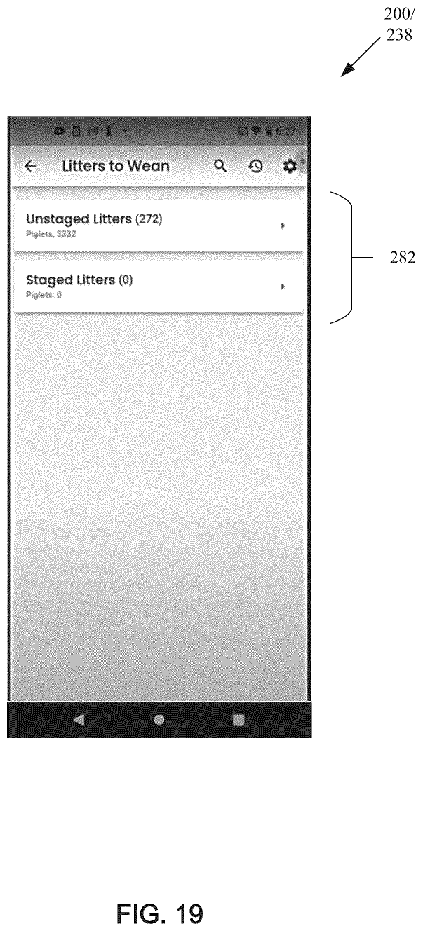

FIGS. 19-21 shows screenshots of an example Liters to Foster tool 234, in accordance with one or more arrangements. In the example arrangement shown, Litter to Wean tool 238 provides a collapsible list 282 to facilitate browsing and selection of litters to ween. In this example arrangement, a worker 26 may easily select an entire room or may select individual crates in a room. In this example arrangement, a worker 26 may also adjust piglet inventory in crates in case discrepancy if discovered. In this example arrangement, a worker may complete selection of litters to week by selecting a button 284. Once litters are selected for weening, the selected piglets are transferred to Gestation Dashboard 206. In one or more arrangements, operations coordination software 74 may be configured to automatically create and/or assign one or more tasks to physically transfer piglets for weening.

### Farrowing Issues Tool 240:

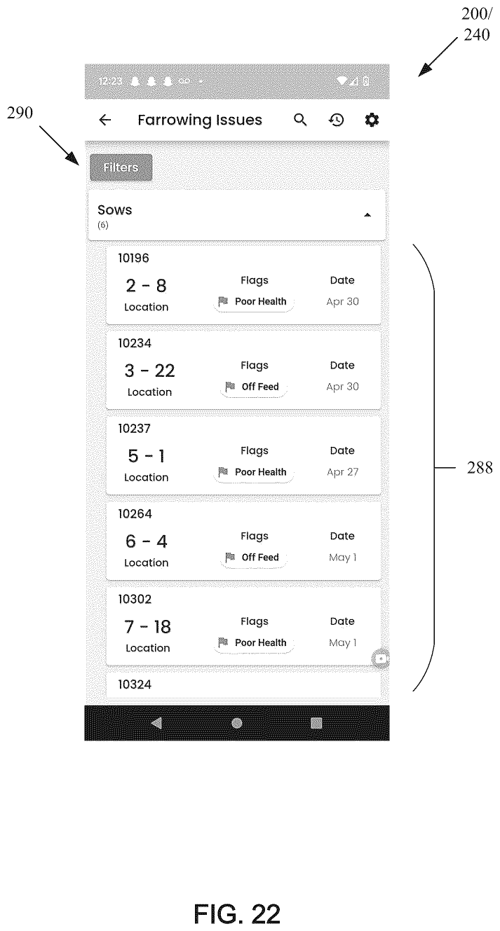

FIGS. 22-33 shows screenshots of an example Farrowing Issues tool 240, in accordance with one or more arrangements. In the example arrangement shown, Farrowing Issues tool 240 allows workers 26 to easily view information on sows that have been flagged for various at risk conditions.

In the example shown in FIG. 22, Farrowing Issues tool 240 provides a scrollable list 288 of all sows and/or litters that are flagged. In this example arrangement, a worker 26 may filter the list 288 by clicking button 290 to bring up filter interface 292 in a pop-up window. In this example, filter interface 292 permits a worker 26 to filter by selected conditions. However, the arrangements are not so limited. Rather, as previously discussed, in some arrangements, filter interface 292 may permit workers to sort and/or filter based on location (e.g., building or room), by the worker 26 (e.g., filtered to sows assigned to the worker 26), by risk, and/or any other filter or sorting criteria).

### Early Pig Care Tool 242:

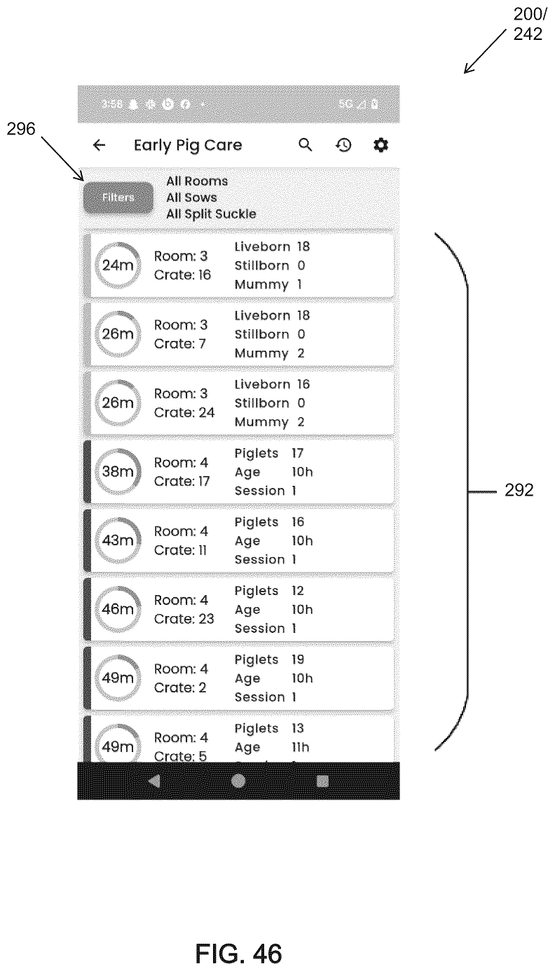

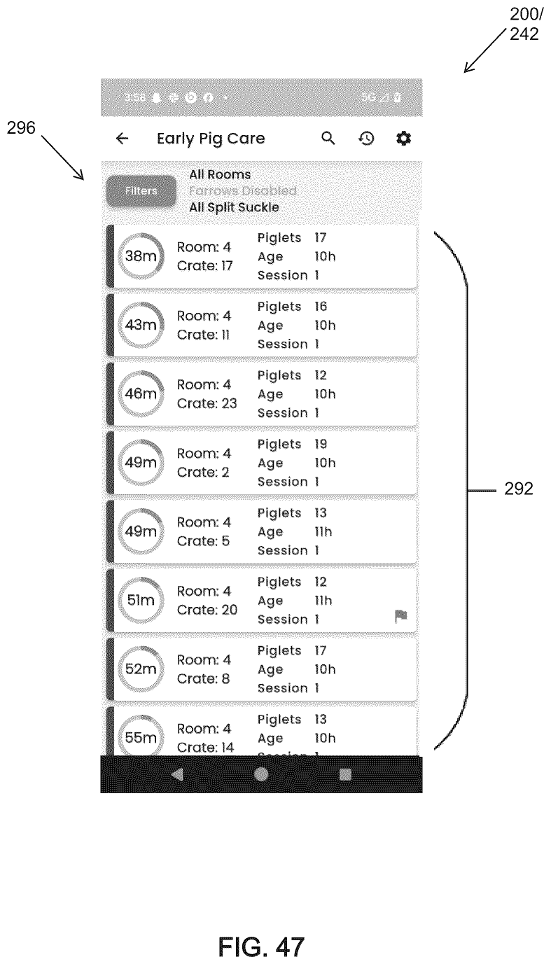

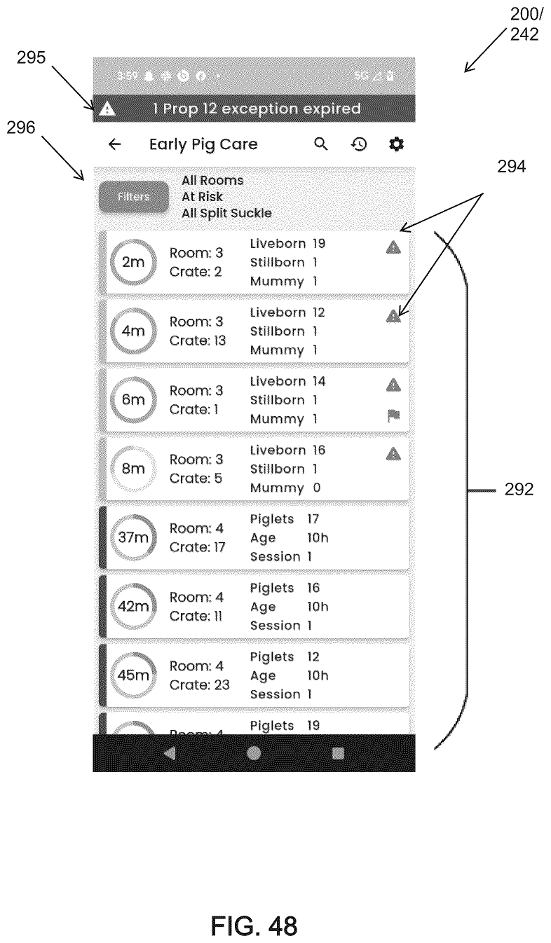

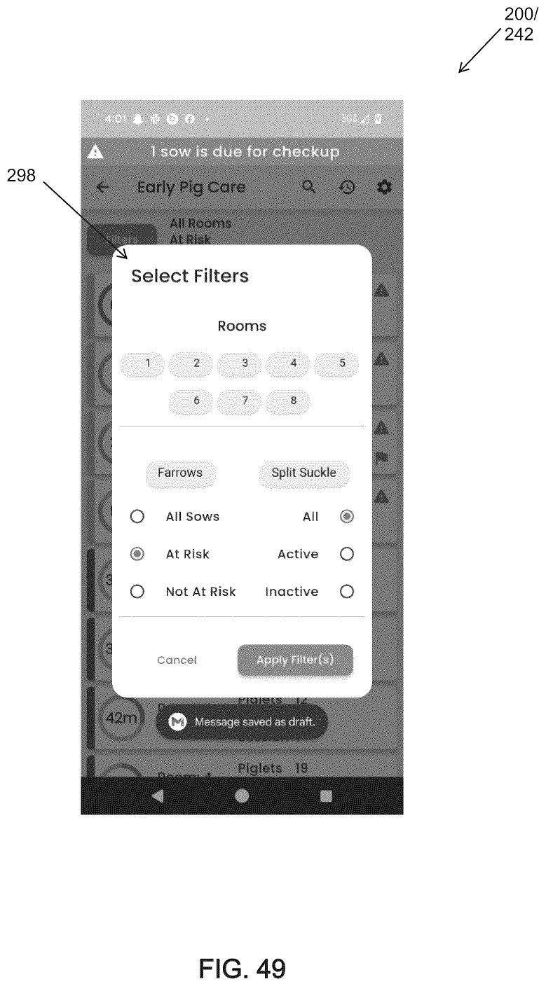

FIGS. 46-49 show screenshots of an example Early Pig Care tool 242, in accordance with one or more arrangements. In one or more arrangements, Early Pig Care tool 242 is similar to Farrow Tracker tool 232 but is configured to additionally or alternatively allows workers 26 to easily view information on sows and/or piglets to facilitate and coordinate split suckling and/or other care of newborn piglets. In the example shown in FIG. 12, Early Pig Care tool 242 provides a scrollable list 292 of all sows currently farrowing. In this example, the list is sorted by the time remaining on the check in timers set by operations coordination software 74 (e.g., time to rotating split suckling groups). In some arrangements, user interface 200 may additionally or alternatively be configured to push a notification or otherwise provide an alert with a check in timer has expired. In this example arrangement, Early Pig Care tool 242 provides a warning icon 294 to indicate when piglets and/or sows in a group may be at risk or the care is not incompliance with a set policy. In this example arrangement, Early Pig Care tool 242 also provides a separate warning 295 to indicate when a Proposition 12 exception is or will soon expire.

In this example arrangement, a worker 26 may filter the list 292 by clicking button 296 to bring up filter interface 298 in a pop-up window. In this example, filter interface permits a worker 26 to filter by room or determined risk level of the sows. However, the arrangements are not so limited. Rather, as previously discussed, in some arrangements, user interface 200 may permit workers to sort and/or filter based on location (e.g., building or room), by the worker 26 (e.g., filtered to sows assigned to the worker 26), by risk, and/or any other filter or sorting criteria). In one or more arrangements, when it is time to perform a check-in of a sow/litter, a worker 26 may easily select the sow from the list to invoke a check in interface 268 to facilitate reporting and update of information.

### Gestation Dashboard 206:

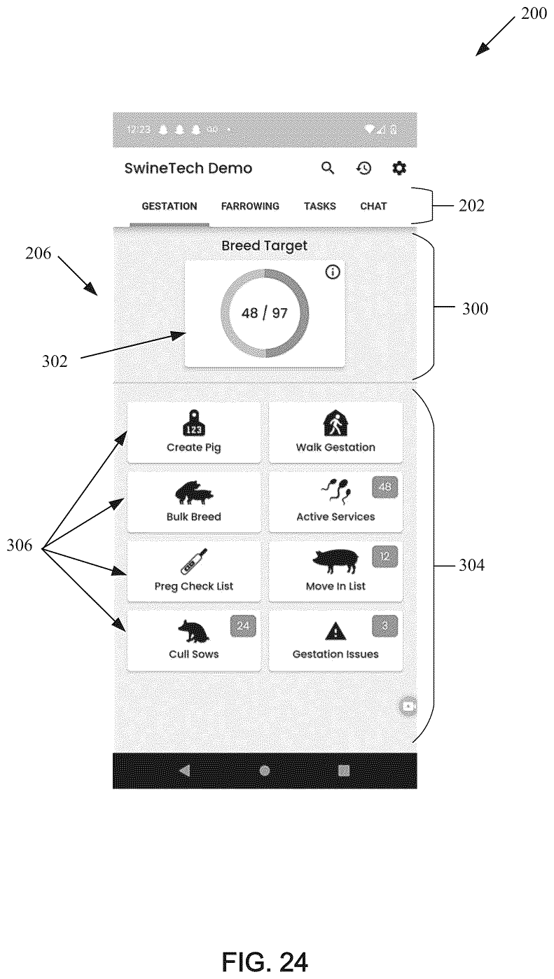

FIGS. 24-38 show screenshots of the gestation dashboard 206, in accordance with one or more arrangements. In this example, gestation dashboard 206 displays some cumulative breeding statistics in an upper panel 300. More specifically, in this example, upper panel 300 includes a tile 302 showing the number of sows bred and the breeding target. In this example arrangement, if a user clicks on one of the tiles 216, a pop-up window (not shown) is displayed showing additional statistics.

In this example, gestation dashboard 206 provides tiles 306 in a lower panel 304 that provide access to a set of tools as well as some high level summary information. In this example, gestation dashboard 206 includes tiles 306 for a Create Pig tool 310, a Walk Gestation tool 312, a Bulk Breed tool 314, an Active Services tool 316, a Pregnancy Check List tool 318, a Move In List tool 320, a Cull Sows tool 322 and a Gestation Issues tool 324. However, the arrangements are not limited to these specific tools. Rather, it is envisioned that in some various arrangements, gestation dashboard 206 may be adapted to have any number of additional or alternative tools. In this example arrangement, a worker 26 may navigate to each tool by simply clicking on the respective tile 306 for the tool.

### Create Pig Tool 310:

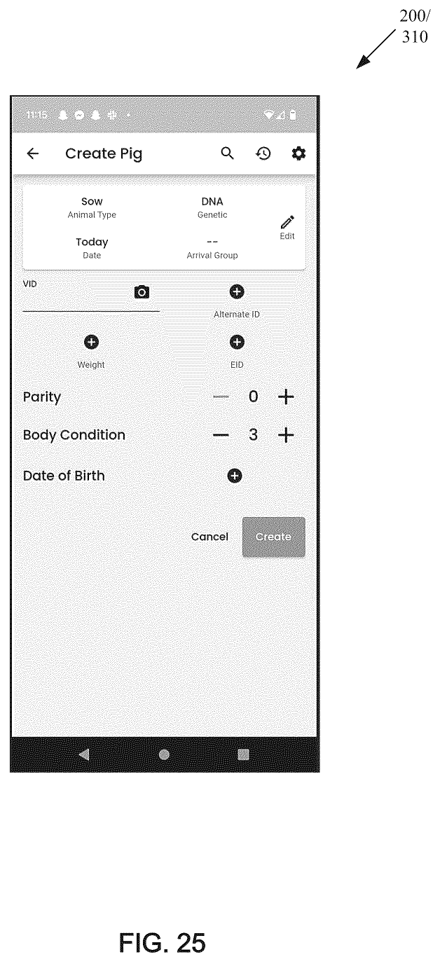

FIG. 25 shows an example screenshot of Create Pig tool 310, in accordance with one or more arrangements. In this example arrangement, Create Pig tool 310 provides a user interface to create a new pig into the operations coordination software 74 and enter pertinent information (e.g., tag ID, sex, age, weight, breed, parity, acquisition data and/or cost, medical history, and/or any other information).

### Walk Gestation Tool 312:

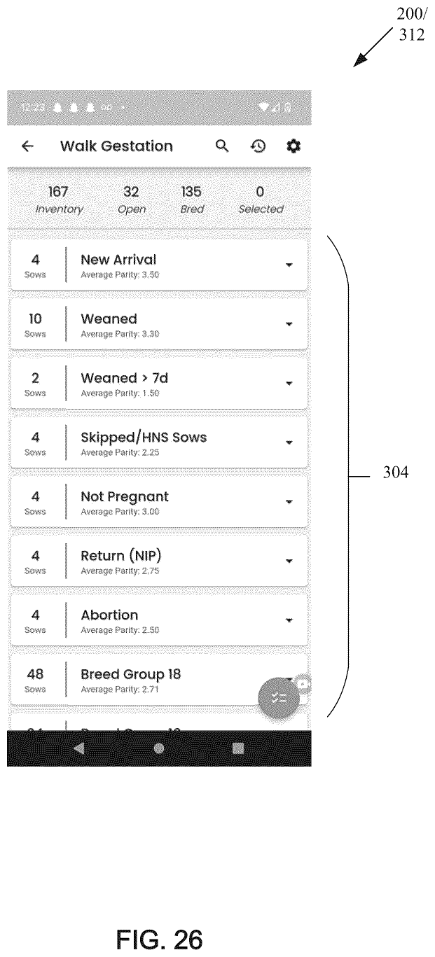

FIG. 26 shows an example screenshot of Walk Gestation tool 312, in accordance with one or more arrangements. In this example arrangement, Walk Gestation tool 312 provides a summary of information for swine not currently farrowing organized as a virtual walk through by a worker 26. For instance, in this example, Walk Gestation tool 312 shows a summary of swine in a scrollable expandable list 328 organized into a set of categories (e.g., Gilts, New Arrival, Weaned, Weaned>7 days, Skipped/HNS Sows, Not Pregnant, Return (NIP), Abortion, and/or Breed Groups). In one or more arrangements, operations coordination software 74 automatically places swine in the appropriate category as information is updated in the system. For example, after one or more litters are selected for weening, they are automatically placed into the weaned category.

In this example, a worker 26 may click on a category in the list 328 to expand the list 328 to display a summary of information for all pigs in that category. In one or more arrangements, a worker 26 may click on an individual pig bring up an interface (not shown) to view and/or edit information for the pig.

In some arrangements, Walk Gestation tool 312 is configured to permit a worker 26 to further filter and/or sort pigs, for example, based on location (e.g., building or room), proximity to the worker's geolocation, by the worker 26 (e.g., filtered to pigs assigned to the worker 26), by medical condition, and/or any other filter or sorting criteria).

In one or more arrangements, Walk Gestation tool 312 provides a warning icon 294 to indicate when a sow in a group may be at risk or the care is not incompliance with a set policy. In this example arrangement, Walk Gestation tool 312 also provides a warning 295 to indicate when a Proposition 12 exception is or will soon expire.

### Active Services Tool 316:

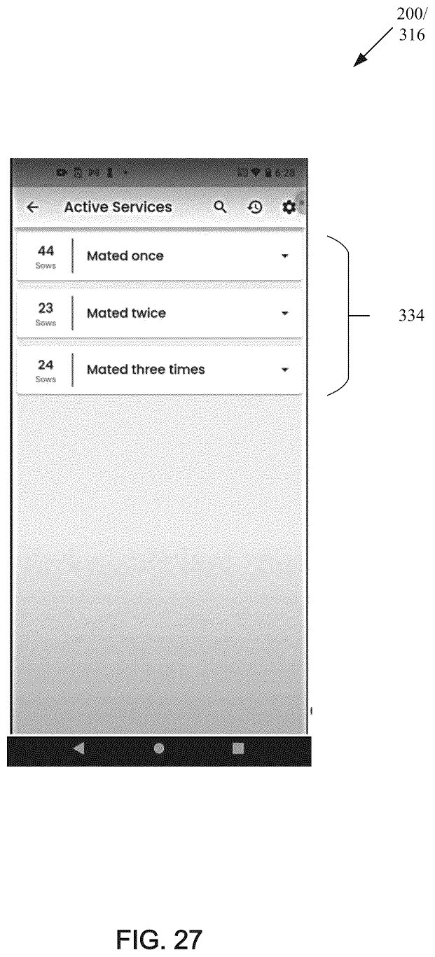

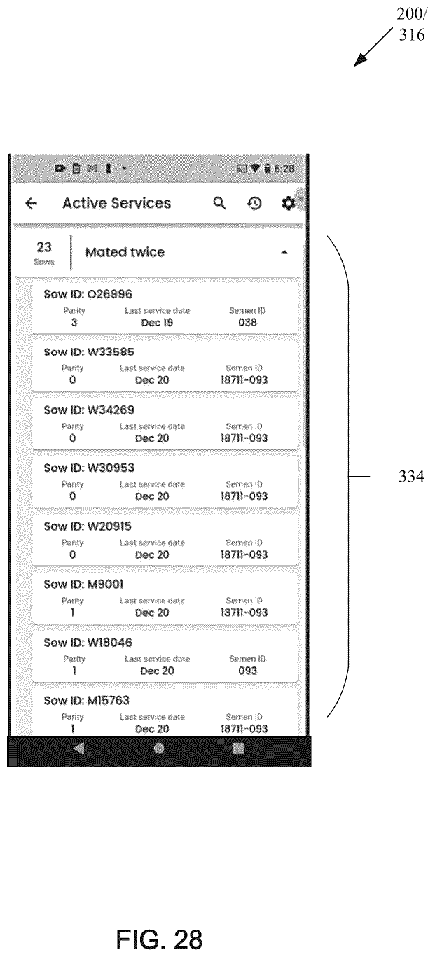

FIGS. 27-28 show example screenshots of Active Services tool 316, in accordance with one or more arrangements. In this example arrangement, Active Services tool 316 provides a user interface to view sows that are actively being breed. In this example arrangement, Active Services tool 316 shows a summary of such sows in a scrollable expandable list organized into groups by the number of times they have been mated. In this example arrangement, a worker 26 may simply click on a group to expand the list and view information for individual sows in the group, for example, as shown in FIG. 28.

### Bulk Breed Tool 314:

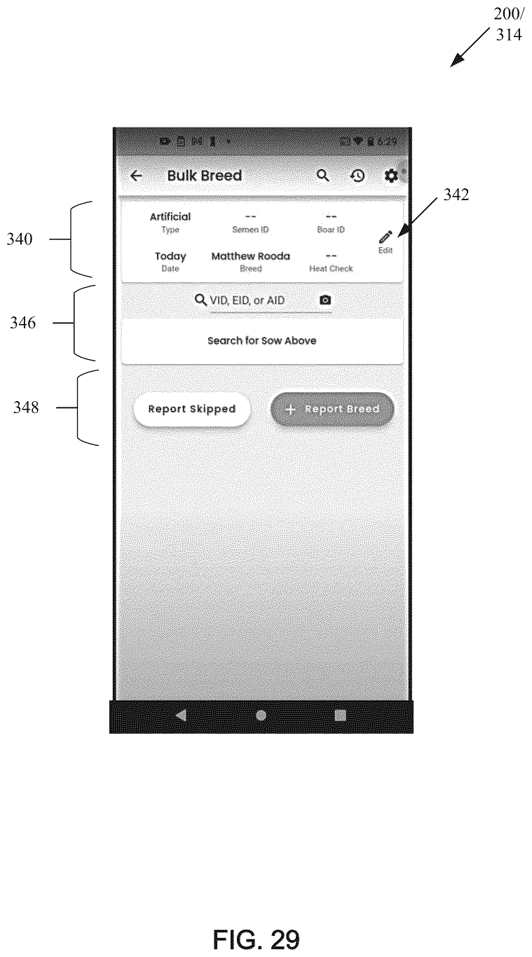

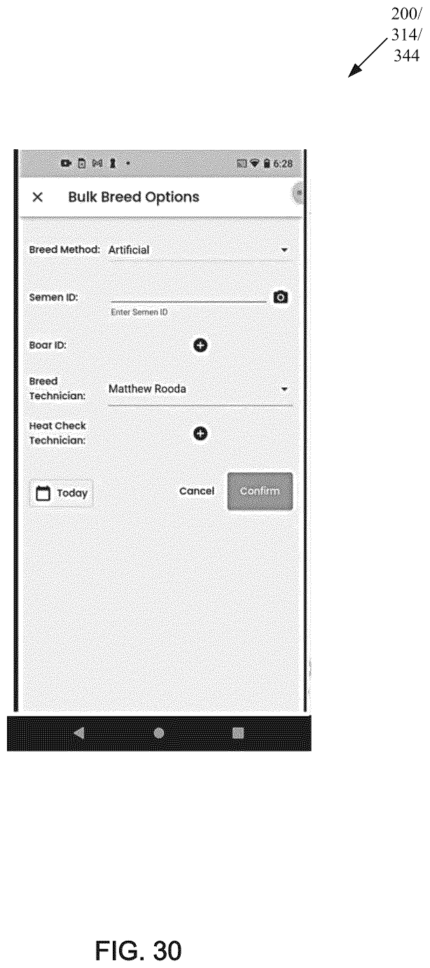

FIGS. 29-31 show example screenshots of Bulk Breed tool 314, in accordance with one or more arrangements. In this example arrangement, Bulk Breed tool 314 is configured to facilitate easy review and input of information by a worker 26 when breeding sows. In this example arrangement, Bulk Breed tool 314 includes an upper panel 340 indicating general mating details that will be included in the medical record for each sow when the mating event is recorded. In this example arrangement, a worker may click edit button 342, which brings of an interface 344 to input and/or adjust the information (e.g., as shown in FIG. 30).

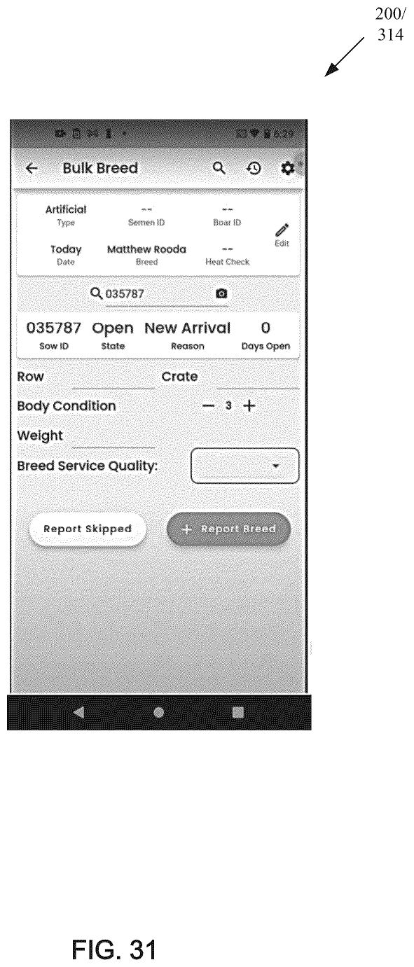

In this example arrangement, Bulk Breed tool 314 includes a lower panel 346 having and interface for a worker to specify the sow being bred. In this example arrangement, a worker 26 may manually input an ID number or may scan a QR code, bar code, or ID on a tag of the animal (e.g., using camera 52 on a personal electronic device 14 on this user interface 200 is provided). In one or more arrangements, once a sow is identified, some additional information for the sow may be shown in lower panel 346 (e.g., as shown in FIG. 31).

In this example, arrangement, Bulk Breed tool 314 includes buttons 348 to report or skip reporting of the identified sow. As an illustrative example of operation, if a number of sows are being artificially inseminated with semen of the same boar, the worker need only input information in panel 340 once and then may simply scan an id tag of each sow as they are inseminated and press report breed button 348.

### Pregnancy Check List Tool 318:

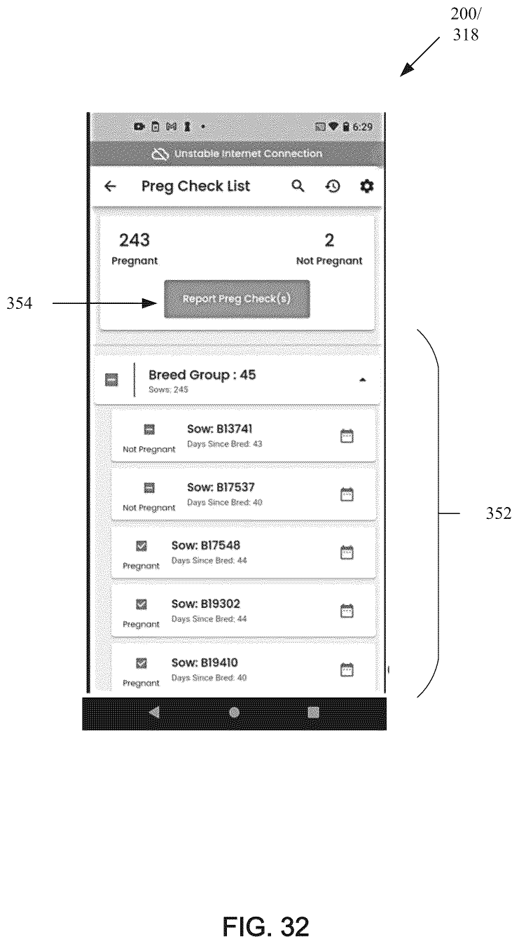

FIG. 32 shows an example screenshot of Pregnancy Check List tool 318, in accordance with one or more arrangements. In this example arrangement, Pregnancy Check List tool 318 is configured to facilitate easy reporting of updating information when pregnancy checks are performed following mating. In this example arrangement, Pregnancy Check List tool 318 includes a scrollable and expandable list 352 of active breeding sows organized by breeding groups. In this illustrative example, workers 26 performing pregnancy checks may simply expand a selected breeding group and marks the entire group and/or individual sows as pregnant or not pregnant. In this example, after marking pregnancy status, a worker 26 may report the pregnancy check by simply selecting button 354.

### Move in List Tool 320:

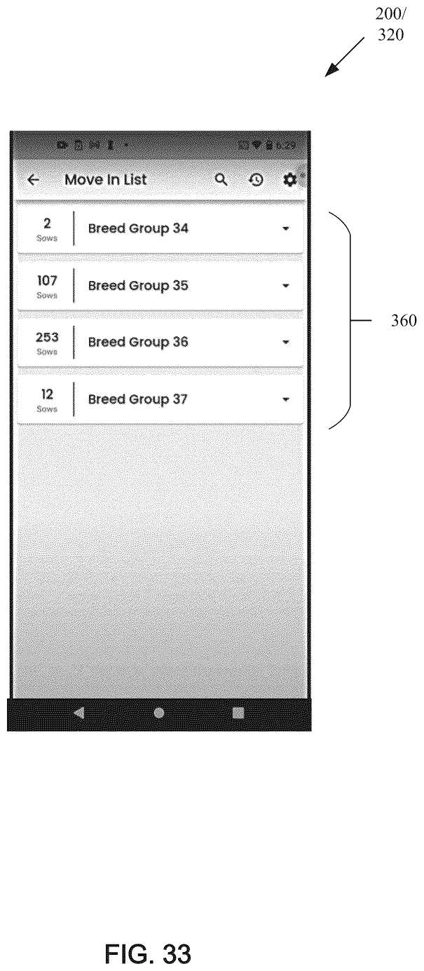

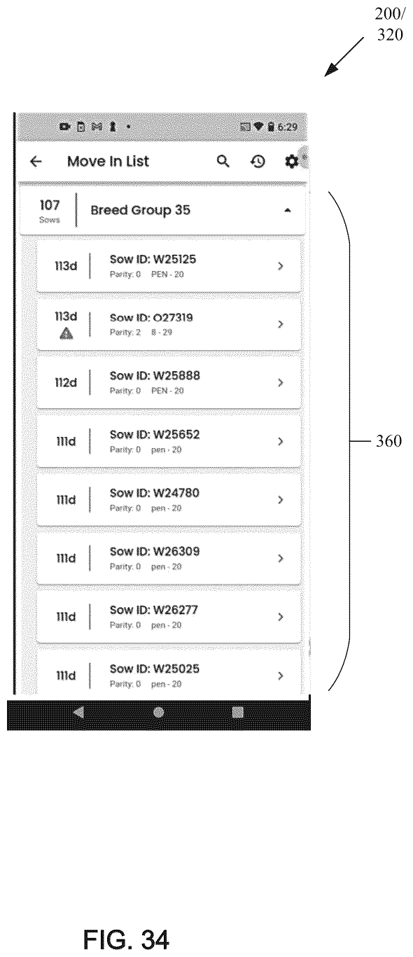

FIGS. 33-34 shows example screenshots of Move In List tool 320, in accordance with one or more arrangements. In this example arrangement, Move In List tool 320 is configured to facilitate easy review of information for all sows set to be moved into farrowing when ready. In this example arrangement, Move In List tool 320 includes a scrollable and expandable list 360 of sows in gestation organized by breeding groups. In this illustrative example, workers 26 performing pregnancy checks may simply expand a selected breeding group to view information on individual sows in the group (e.g., how many days the sow has been in gestation and whether a sow has been identified as high risk).

### Cull Sows Tool 322:

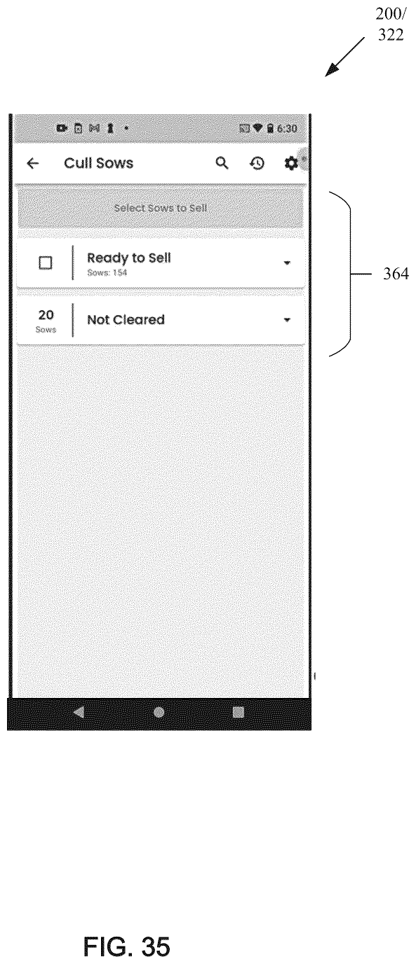

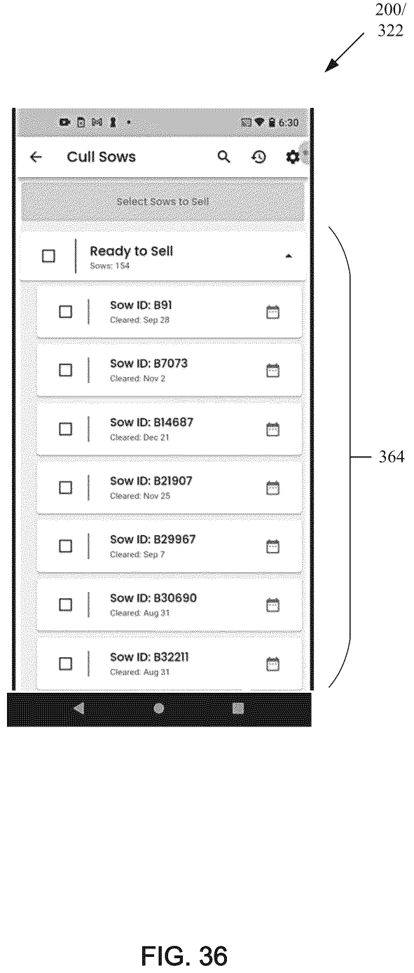

FIGS. 35-36 shows example screenshots of Cull Sows tool 322, in accordance with one or more arrangements. In this example arrangement, Cull Sows tool 322 is configured to facilitate easy confirmation sows selected for sale are correct and cleared for sale. In this example arrangement, Cull Sows tool 322 includes a scrollable and expandable list 364 of culled sows organized into two groups: sows that have not been cleared to sell, and sows that are ready to sell. In one or more arrangements, a worker 26 can expand either group to view and/or update information on individual sows. In one or more arrangements, if information is updated to record medical treatment of a sow in the ready to sell group, operations coordination software 74 is configured to automatically move the sow to the not cleared group while they are under active withdrawal. In one or more arrangement, Cull Sows tool 322 is configured to indicate what date a treated sow in the not cleared list will be cleared. In one or more arrangements, operations coordination software 74 is configured to automatically move the sow back to the ready to sell group once active withdrawal has expired.

### Gestation Issues Tool 324:

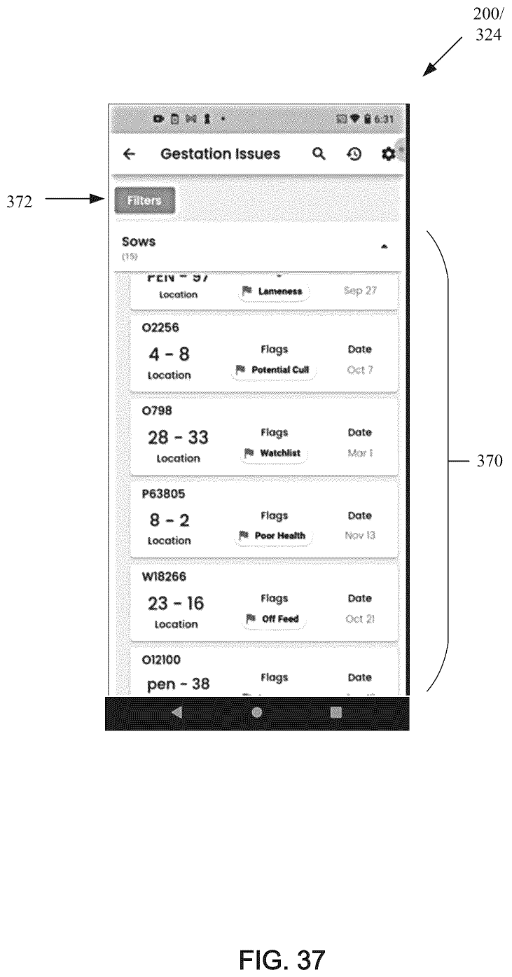

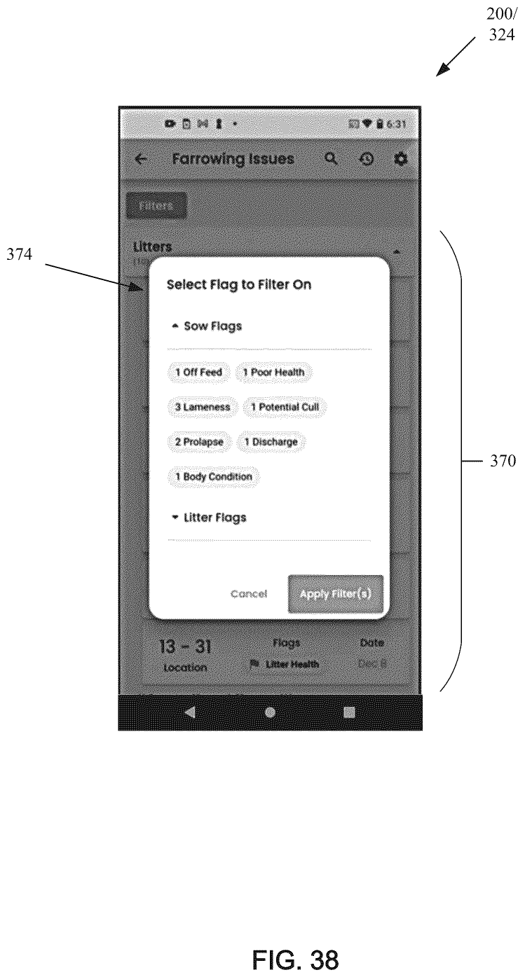

FIGS. 37-38 shows screenshots of an example Gestation Issues tool 324, in accordance with one or more arrangements. In the example arrangement shown, Gestation Issues tool 324 allows workers 26 to easily view information on sows that are not currently farrowing and that have been flagged for various at risk conditions. In the example shown in FIG. 37, Gestation Issues tool 324 provides a scrollable list 370 of all sows that are flagged. In this example arrangement, a worker 26 may filter the list 30 by clicking button 372 to bring up filter interface 374 in a pop-up window (e.g., as shown in FIG. 38). In this example, filter interface 374 permits a worker 26 to filter by selected conditions. However, the arrangements are not so limited. Rather, as previously discussed, in some arrangements, filter interface 374 may permit workers to sort and/or filter based on location (e.g., building or room), by the worker 26 (e.g., filtered to sows assigned to the worker 26), by risk, and/or any other filter or sorting criteria).

### Task Dashboard 208:

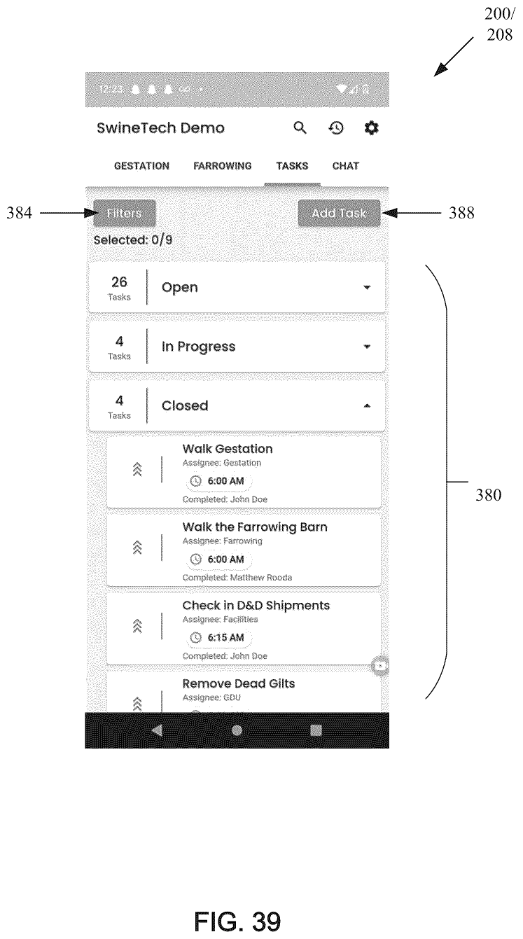

FIGS. 39-43 shows screenshots of an example Task Dashboard 208, in accordance with one or more arrangements. In the example arrangement shown, Task Dashboard 208 is configured to facilitate the creation, review and/or completion of tasks managed by operations coordination software 74. In the example arrangement shown, Task Dashboard 208 provides a scrollable expandable list 380 of all tasks organized into groups of open tasks, tasks in progress, and tasks that are closed. In one or more arrangements, a worker 26 may click on a selected task to bring up a pop-up interface 382 configured to provide additional information on the task and/or update status of the task (e.g., open, started, closed, etc.). In this example arrangement, pop-up interface 382 shows a description of the task, a priority assigned to the task (if any), a status of the task, the person or group the task is assigned to (if any), and the person or process that created the task. However, the arrangements are not so limited. Rather, it is contemplated that in some various arrangements, pop-up interface 382 may be configured to provides various alternative or additional information relating to the tasks.

In this example arrangement, a worker 26 may filter the list 380 of tasks by clicking button 384 to bring up filter interface 386 in a pop-up window. In this example, filter interface 386 permits a worker 26 to filter by category of the task or worker or group assigned the task. However, the arrangements are not so limited. Rather, as previously discussed, in some arrangements, user interface 200 may permit workers to sort and/or filter tasks based on location (e.g., building or room), proximity to the location of the task (e.g., based on geolocation of the worker 26), by the worker or group assigned the task (e.g., filtered to sows assigned to the worker 26), by priority of the task, by time to task deadline, and/or any other filter or sorting criteria.

In one or more arrangements, a worker 26 may create a new task by clicking button 388 to bring up interface 390. In this example arrangement, interface 390 permits a worker 26 to provide a name for the task along with a description, priority, and deadline. In this example arrangement, interface 390 permits a worker 26 to specify if the deadline can rollover to the following day and/or if the task should be scheduled on a reoccurring basis. In this example arrangement, interface 390 permits the worker 26 to assign the task to one or more individuals or groups, for example, as previously described with reference to operations coordination software 74.

### Chat Interface 210:

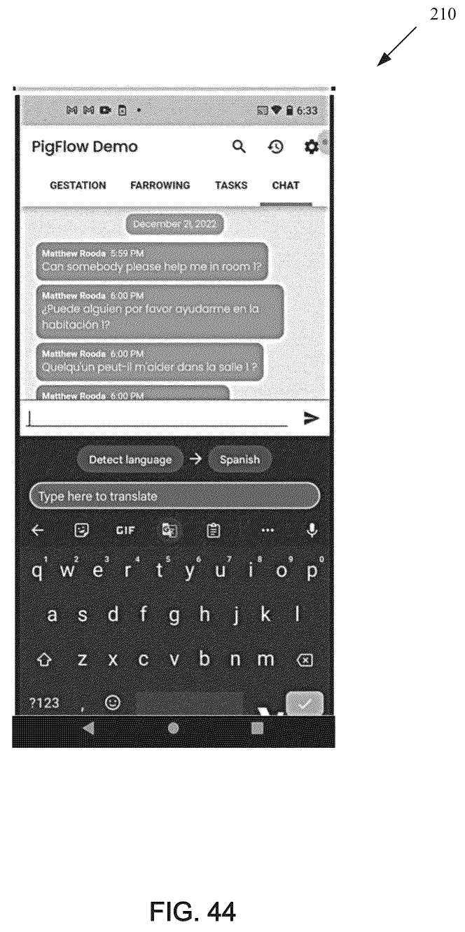

In one or more arrangements, user interface 200 includes a chat interface to facilitate communication between workers 26, for example, to coordinate completion of tasks. FIG. 44 shows a screen shot of an example chat interface 210, in accordance with one or more arrangements. In this example arrangement, chat interface 210 is a text based interface and can be used to send text based messages to one or more persons or groups of persons. In the arrangement shown, chat interface 210 is also configured to permit a sender and/or recipient to translate a message between languages at a click of a button. However, the arrangements are not so limited. Rather, it is contemplated that in some various arrangements, chat interface 210 may be configured to facilitate any additional or alternative forms of communication.

### Interface 400 of Operations Coordination Software 74:

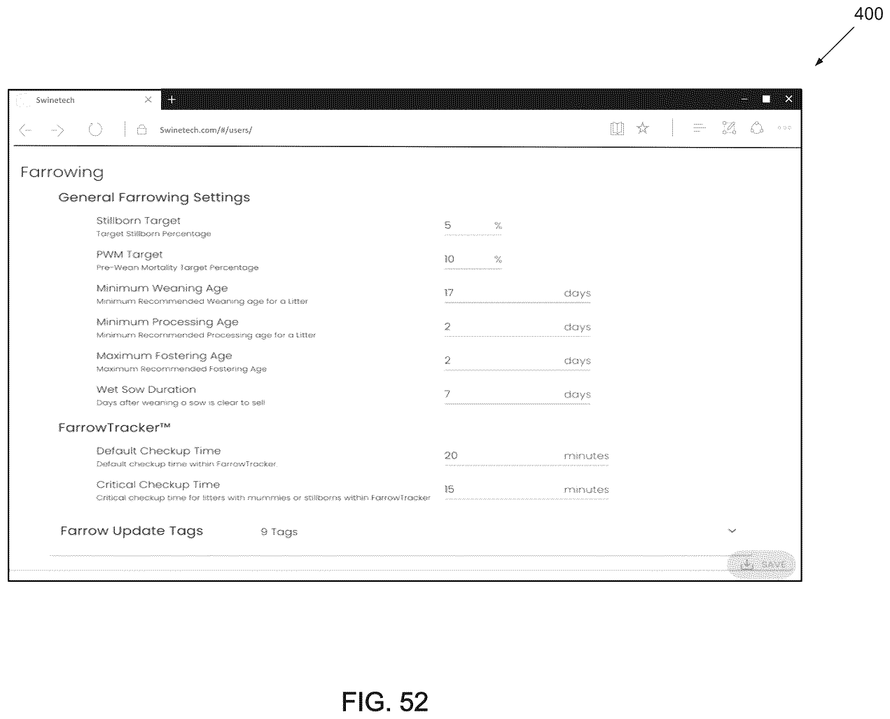

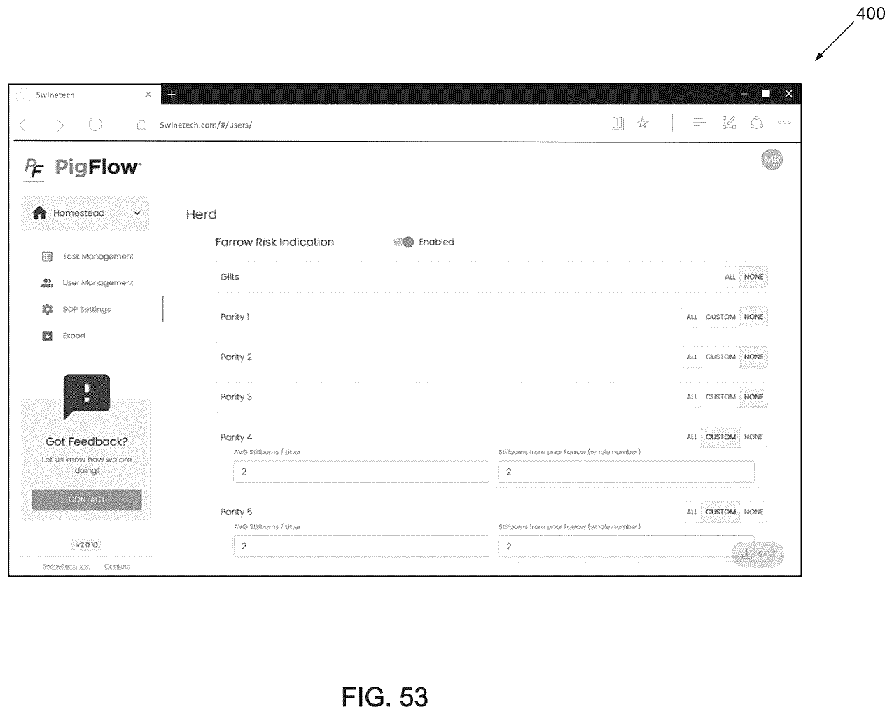

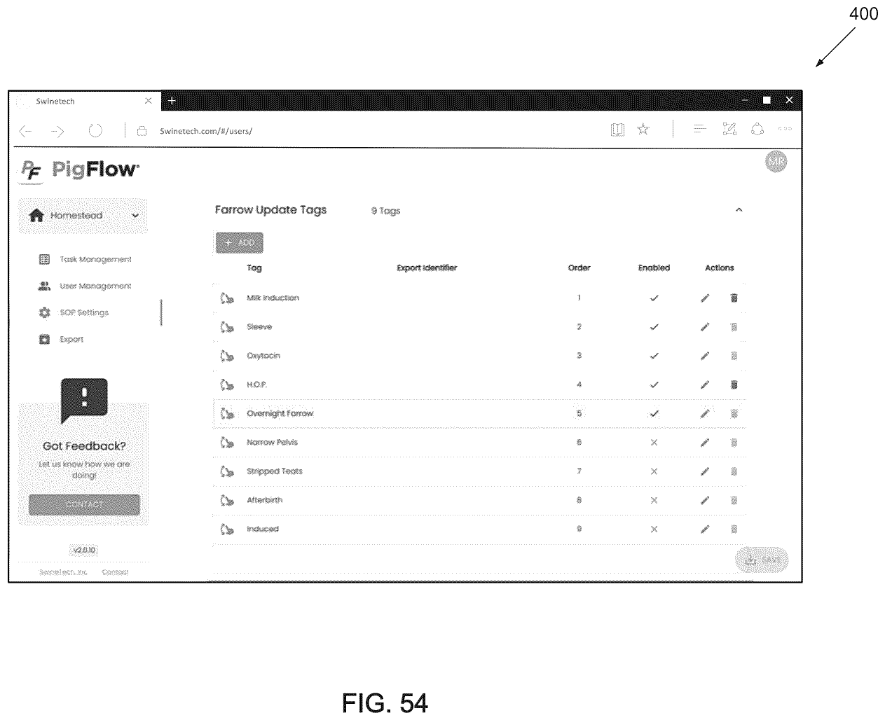

In one or more arrangements, operations coordination software 74 is configured to provide an interface 400 to facilitate configuration of various settings and options of operations coordination software 74, for example, by a manager or other authorized. As some non-limiting examples, configuration interface 400 may be configured to set permissions of workers, review and evaluate task performance, configure settings for identification of high risk sows, settings for identification of complications, criteria for performance of automated action and/or automated creation of tasks. FIGS. 52-54 show some screenshots of some example interface screens to facilitate setup and configuration of some example settings for operations coordination software, in accordance with one or more arrangements. However, the arrangements are not so limited to the examples shown and/or described herein. Rather, it is contemplated that in some various arrangements, operations coordination software 74 may be configured to provide a configuration interface 400 with various additional of alternative configuration options and/or in any alternate format or interface layout.

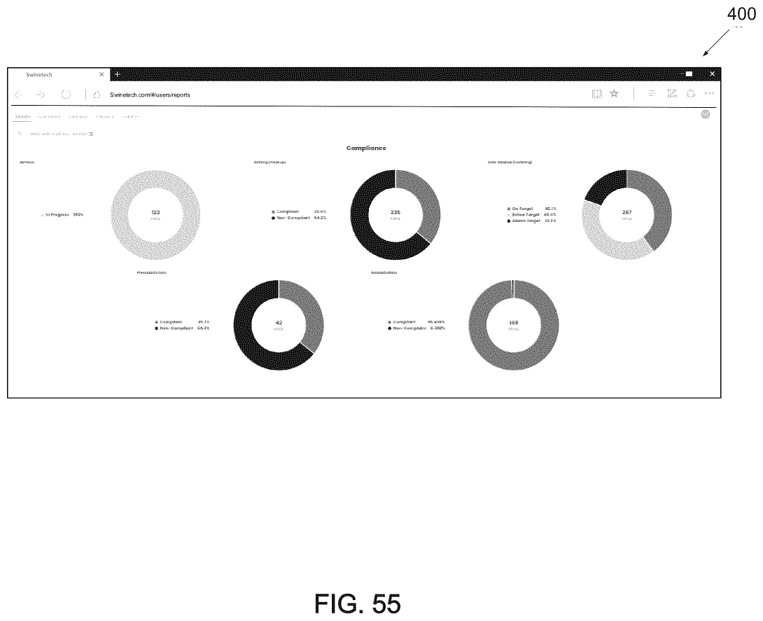

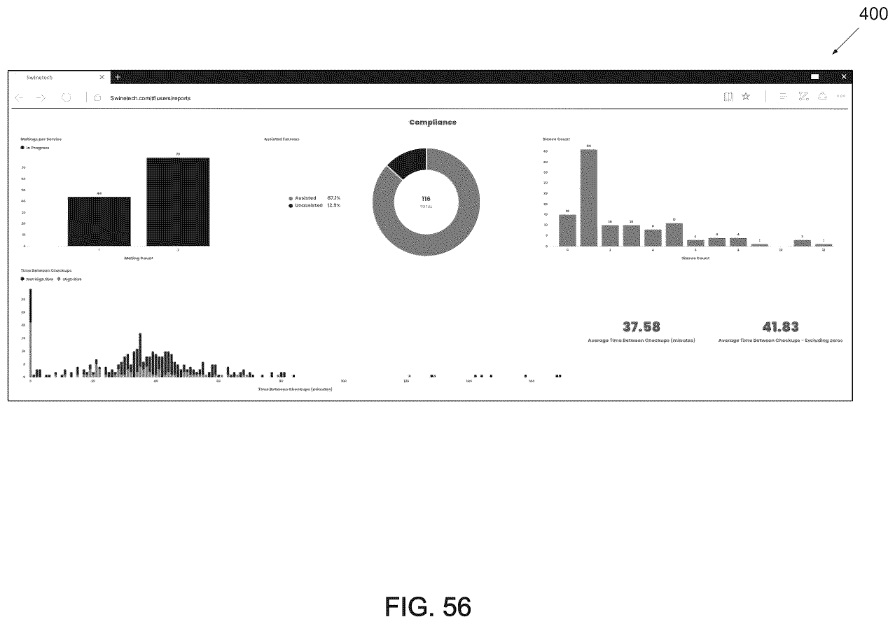

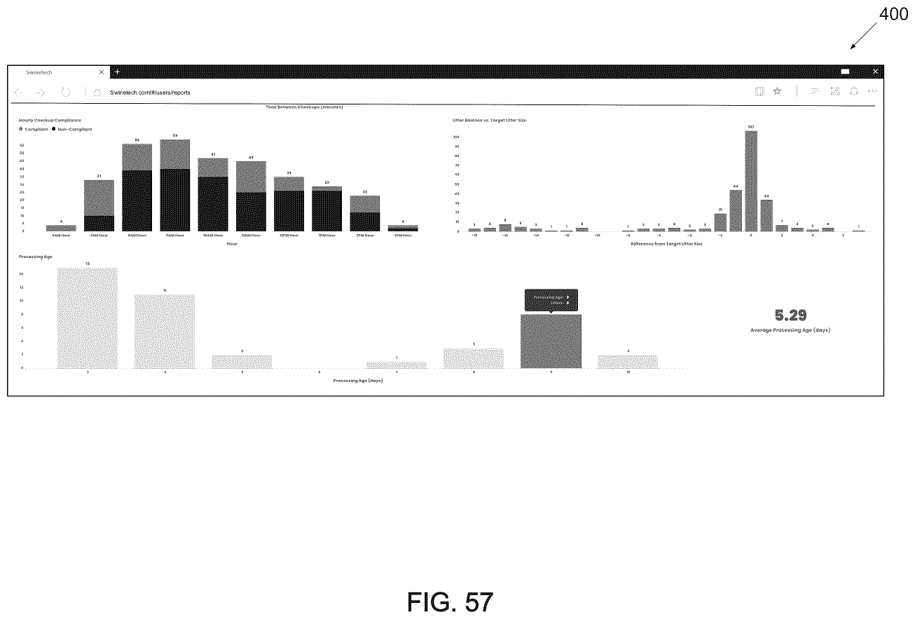

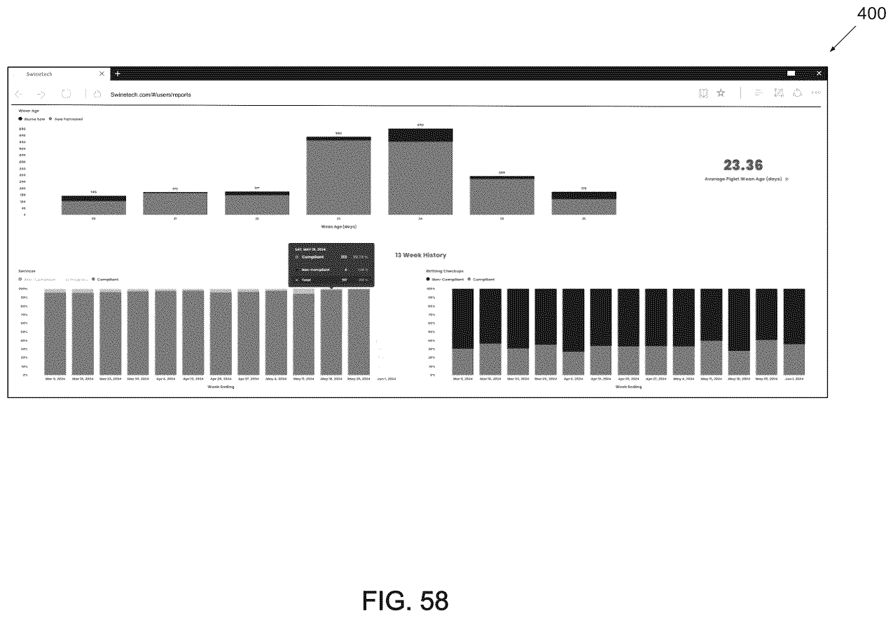

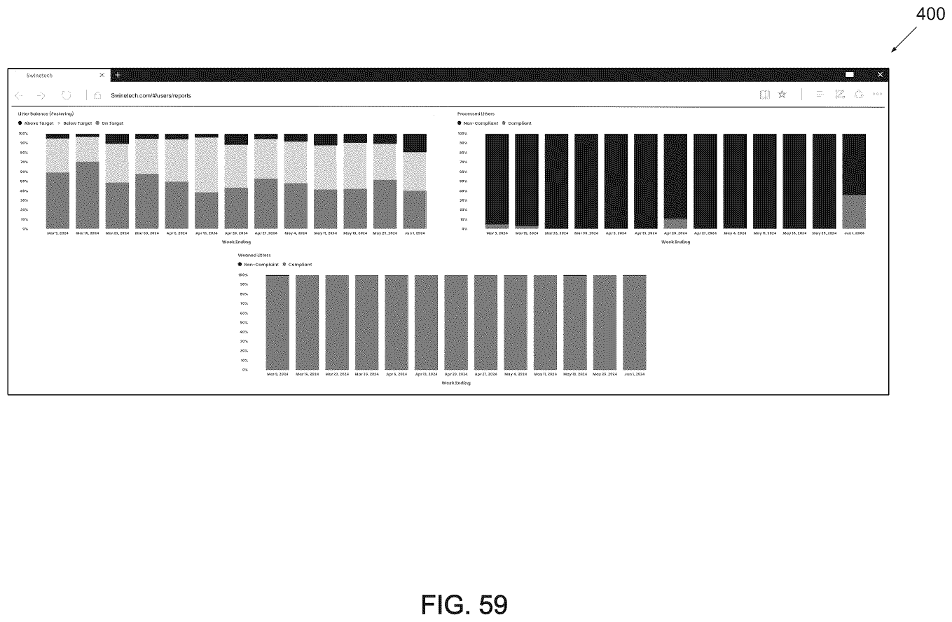

In one or more arrangements, interface 400 may be additionally or alternatively configured to facilitate review of various data metrics tracked by system 10, derived by data analytics processes. Additionally or alternatively, in some various arrangements interface 400 may be configured to facilitate review of compliance with various policies, standards, and/or regulations. FIGS. 55-59 show some screenshots of some example reports that may be generated by interface 400 of operations coordination software to facilitate review of various data metrics tracked by operations coordination software and/or compliance with various policies, standards, and/or regulations, in accordance with one or more arrangements.

From the above discussion it will be appreciated that the system 10 presented herein improves upon the state of the art. More specifically, and without limitation, it will be appreciated that in one or more arrangements, an improved system for tracking, coordination, and/or control of livestock is provided that improves upon the state of the art; that facilitates tracking and management of farrowing operations for livestock; that automatically identifies livestock at high risk of complications during farrowing; that schedules and tracks check ins on farrowing livestock; that dynamically schedules and tracks check ins on farrowing livestock based on determined risk; that reduces risk and increases birthing rates in farrowing; that facilitates creation and tracking of tasks; that is high quality; that is easy to use; and/or that is reliable. These and other objects, features, or advantages of the disclosure will become apparent from the specification, figures, and claims.

It will be appreciated by those skilled in the art that other various modifications could be made to the device without parting from the spirit and scope of this disclosure. All such modifications and changes fall within the scope of the claims and are intended to be covered thereby.

What is claimed is:

1. A system, comprising:
a backend system;
a personal electronic device communicatively connected to the backend system;
wherein the personal electronic device is configured to provide a user interface for a user to monitor and update statuses of a set of farrowing livestock animals in the backend system;
wherein the user interface is configured to display a listing of the set of farrowing livestock animals;
user interface is configured to display respective timers until next required check in for the set of farrowing livestock animals;
wherein the listing of the set of farrowing livestock animals is sorted according to the times remaining on the respective timers for the set of farrowing livestock animals.

2. The system of claim 1, wherein the backend system is configured to determine a birthing risk for each of the set of farrowing livestock animals;
wherein the backend system is configured to set times of the respective timers for the set of farrowing livestock animals based on the determined birthing risk.

3. The system of claim 1, wherein the backend system is configured to determine a birthing risk for each of the set of farrowing livestock animals based on birthing events recorded for previous farrowing cycles;
wherein the backend system is configured to set times of the respective timers for the set of farrowing livestock animals based on the determined birthing risk.

4. The system of claim 1, wherein the backend system is configured to determine a birthing risk for each of the set of farrowing livestock animals based on birthing events recorded for previous farrowing cycles;
wherein the backend system is configured to determine adjust the determined birthing risk for each of the set of farrowing livestock animals based on birthing events recorded for the current farrowing cycle;
wherein the backend system is configured to set times of the respective timers for the set of farrowing livestock animals based on the determined birthing risk;
wherein the birthing events are reported by users via the user interface.

5. The system of claim 1, wherein the backend system is configured to determine a birthing risk for each of the set of farrowing livestock animals based on birthing events recorded for a current farrowing cycle;
wherein the backend system is configured to set times of the respective timers for the set of farrowing livestock animals based on the determined birthing risk;
wherein the birthing events are detected by one or more sensors configured to monitor farrowing progress of the set of farrowing livestock animals.

6. The system of claim 1, wherein the backend system is configured to determine a birthing risk for each of the set of farrowing livestock animals based on birthing history, health status, and birthing events recorded for a current farrowing term;
wherein the backend system is configured to set times of the respective timers for the set of farrowing livestock animals based on the determined birthing risk.

7. A system, comprising:
a backend system;
a personal electronic device communicatively connected to the backend system;
wherein the personal electronic device is configured to provide a user interface for a user to monitor and update statuses of a set of livestock animals in the backend system;
one or more devices configured to provide care for the set of livestock animals;
wherein the backend system is communicatively connected with the one or more devices;
wherein the backend system is configured to adjust operation of the one or more devices based on the statuses of the set of livestock animals in the backend system.

8. The system of claim 7, wherein the one or more devices include an electronic feeding device;
wherein the backend system is configured to cause the electronic feeding device to dispense a first type of feed for one of the set of livestock animals during gestation;
wherein the backend system is configured to cause the electronic feeding device to dispense a second type of feed for the one of the set of livestock animals after birthing.

9. The system of claim 7, wherein the one or more devices include an electronic feeding device;
wherein the backend system is configured to cause the electronic feeding device to dispense feed according to a first feed schedule for one of the set of livestock animals during gestation;
wherein the backend system is configured to cause the electronic feeding device to dispense feed according to a second feed schedule for the one of the set of livestock animals after birthing.

10. The system of claim 7, wherein the one or more devices includes an electronic feeding device;
wherein the electronic feeding device is configured to communicate data to the backend system indicating amounts of food eaten from the electronic feeding device.

11. The system of claim 7, wherein the one or more devices includes a plurality of electronic feeding devices configured to provide feed the set of livestock animals;
wherein the plurality of electronic feeding devices are configured to communicate data to the backend system indicating amounts of food eaten by each of the set of livestock animals;
wherein the backend system is configured to track amounts of feed eaten by the set of livestock animals.

12. The system claim 7, wherein the one or more devices includes a plurality of electronic feeding devices configured to provide feed the set of livestock animals;
wherein the plurality of electronic feeding devices are configured to communicate data to the backend system indicating amounts of food eaten by each of the set of livestock animals;
wherein the backend system is configured to track amounts of feed eaten by the set of livestock animals;
wherein the backend system is configured to provide a user interface indicating which of the set of livestock animals are below target feeding levels.

13. The system of claim 7, wherein the one or more devices includes one or more climate control devices;
wherein the backend system is configured to control the one or more climate control devices based on statuses of the set of livestock animals.

14. The system of claim 7, wherein the user interface is configured to display a listing of the set of farrowing livestock animals;
user interface is configured to display respective timers until next required check in for the set of farrowing livestock animals;
wherein the listing of the set of farrowing livestock animals is sorted according to the time remaining the respective timers for the set of farrowing livestock animals.

15. A system, comprising:
a backend system;
a personal electronic device communicatively connected to the backend system;
wherein the personal electronic device is configured to provide a user interface for a user to monitor and update statuses of a set of livestock animals in the backend system;
wherein the backend system is configured to determine statuses of the set of livestock animals based on data from one or more sensors;
wherein the backend system is communicatively connected with the one or more sensors;
wherein the backend system is configured to adjust operation of one or more devices based on the statuses of the set of livestock animals in the backend system.

16. The system of claim 15, wherein the backend system is configured to determine the statuses of the set of livestock animals based on the data from the one or more sensors and observations input by users via the user interface.

17. The system of claim 15, wherein the backend system is configured to determine the statuses of the set of livestock animals based on the data from the one or more sensors, observations input by users via the user interface, and records from previous farrowing cycles of the set of livestock.

18. The system of claim 15, wherein the one or more sensors includes one or more cameras.

19. The system of claim 15, wherein the one or more sensors includes a set of biometric sensors configured to be worn by the set of livestock animals.

20. The system of claim 15, wherein the one or more sensors includes temperature sensors configured to monitor temperature of crates housing the set of livestock animals.

21. The system of claim 15, wherein the one or more sensors includes sensors configured to monitor CO2 levels in crates housing the set of livestock animals.

22. A system, comprising:
a backend system;
a personal electronic device communicatively connected to the backend system;
wherein the personal electronic device is configured to provide a user interface for a user to monitor and update statuses of a set of livestock animals in the backend system;
wherein the user interface is configured to display a list of the set of livestock animals and their status;
wherein the list is organized according to the geolocation of the set of livestock animals.

23. The system of claim 22, wherein the user interface is configured to filter the list to show a subset of the set of livestock animals that are in close proximity to the personal electronic device.

24. The system of claim 22, wherein the user interface is configured to dynamically filter the list to show a subset of the set of livestock animals that are in close proximity to a geolocation of the personal electronic device.
